(19) United States
(12) Patent Application Publication
(10) Pub. No.: US 2008/0003689 A1
(43) Pub. Date: Jan. 3, 2008

(54) Systems and methods for sample modification using fluidic chambers

(75) Inventors: Clarence C. Lee, Woburn, MA (US); Linda Knaian, Newton, MA (US); Rudolf Gilmanshin, Waltham, MA (US); Emilia Mollova, Woburn, MA (US)

Correspondence Address: WOLF GREENFIELD & SACKS, P.C., 600 ATLANTIC AVENUE, BOSTON, MA, 02210-2206, US

(73) Assignee: U.S. Genomics, Inc., Woburn, MA (US)

(21) Appl. No.: 11/180,980

(22) Filed: Jul. 13, 2005

Related U.S. Application Data
(60) Provisional application No. 60/587,526, filed on Jul. 13, 2004.
(60) Provisional application No. 60/648,547, filed on Jan. 31, 2005.

(51) Int. Cl. G01N 1/00

(52) U.S. Cl. 436/174

(57) ABSTRACT

The invention relates to methods and systems for modifying agents using fluidic fractionation chambers.

### RELATED APPLICATIONS

This application claims priority to U.S. Provisional Applications having Ser. No. 60/587,526 entitled “SAMPLE PREPARATION OF DNA FROM MULTIPLE ORGANISMS USING A SYSTEM COMPRISED OF FLUIDIC CHAMBERS” filed Jul. 13, 2004, and Ser. No. 60/648,547 entitled “SAMPLE PREPARATION OF POLYMERS FROM BIOAEROSOLS USING CENTRIFUGATION AND A FLUIDIC CHAMBER SYSTEM” filed Jan. 31, 2005, the entire contents of both of which are incorporated by reference herein.

### FIELD OF THE INVENTION

The invention relates in part to the modification and analysis of samples using a field flow fractionation device.

### BACKGROUND OF THE INVENTION

The ability to obtain highly purified kilobase and megabase DNA from organisms for detection and analysis is important for a variety of scientific fields, ranging from genomics studies to clinical analysis and biodefence. However, the isolation and purification of DNA, as well as its preparation for analysis, can be both a time-consuming and a laborious process. For example, the isolation of DNA from E. Coli requires a multi-step procedure with frequent buffer and reagents exchanges, precipitation, centrifugation and heating steps to attain the final product. In addition, the above example does not include any purification and preparation of DNA for analysis, which would require even more steps to be performed.

The isolation and separation of large-sized DNA can also be performed using agarose plugs and pulsed-field gel electrophoresis (PFGE), respectively. Agarose plugs allow for the handling of DNA without fragmentation from shearing forces, which can easily occur when manipulating DNA in solution; however, this limits applications to electrophoretic analysis. Bacteria or yeast are typically embedded in agarose plugs, allowing for enzymes to digest the cellular wall and proteins. The large DNA strands are left intact in the plug, which then can be further digested by restriction enzymes if necessary.

PFGE allows for large DNA to be resolved, separating DNA from 30 kilobases (kb) to over 10 megabases (Mb) in length. PGFE is an epidemiologic tool that has been able to identify outbreaks which eluded traditional detection methods (Bender et al., New England Journal of Medicine, 1997, 337(6): p. 388-394). However, there are several disadvantages with using PGFE (Noller et al., Journal of Clinical Microbiology, 2003. 41(2): p. 675-679). As with other current isolation and separation protocols, PGFE can be a time-consuming and labor-intensive process. Pulsed-field gels are typically run overnight for appropriate DNA separation. In addition, large sample sets are not easily handled. The information directly obtained from PFGE is qualitative, leading to subjective interpretation and a lack of data transferability between different laboratories. A more quantitative analysis of DNA separated by PFGE would require a further extraction procedure and undoubtedly some sample loss.

Collection and preparation of bioaerosol samples for analysis is important in the biodefence field. Bioaerosols may consist of airborne biological materials, such as fungal spores, bacteria, viruses and cellular fragments (Lee et al., Journal of Aerosol Science, 2003. 34: p. 1097-1100; Stetzenbach et al., Current Opinion in Biotechnology, 2004. 15: p. 170-174). The sample particulates are generally 0.3-100 μm in diameter, with the main concern being the 1-10 μm size since these particulates can be readily inhaled (Stetzenbach et al., Current Opinion in Biotechnology, 2004. 15: p. 170-174; Cox, C. S, and C. M. Wathes, eds. Bioaerosols Handbook. 1995, Lewis Publishers: Boca Raton). Air sampling technology is sufficiently developed. Sample fractionation is based on aerodynamic properties which in turn are dependent on particle size and mass. Although there is high collection efficiency for particles less than 10 μm in diameter, the sampling characteristics for large particles are relatively unknown (Cox, C. S, and C. M. Wathes, eds. Bioaerosols Handbook. 1995, Lewis Publishers: Boca Raton). Since airborne microorganisms are often present as aggregates (Stetzenbach et al., Current Opinion in Biotechnology, 2004. 15: p. 170-174), there is a risk of sample loss due to air sampling inefficiency. Also, particulates such as diesel particulates and dust are collected along with the bioaerosol. This environmental background can therefore interfere with the sampling preparation, analysis and detection of airborne pathogens (Stetzenbach et al., Current Opinion in Biotechnology, 2004. 15: p. 170-174).

There exists a need for a method and/or system for fractionating particulates in samples such as air samples as well as a need for more efficient manipulation and/or modification of components of such samples such as nucleic acids.

### SUMMARY OF THE INVENTION

The invention provides apparatuses, systems and methods for detecting, analyzing and/or modifying agents. The various aspects of the invention employ fluidic fractionation systems such as field-flow fractionation (FFF) systems to modify the target agent. Various reactions may be performed within a fluidic fractionation device including but not limited to concentration, lysis, and covalent or non-covalent modification of an agent. The agent may be cellular or molecular in nature. The agent is usually provided in a sample which may comprise a plurality of agents. The invention provides the ability to manipulate (or modify) polymers such as for example nucleic acids without significant shearing or fragmentation.

In some aspects of the invention, a single chamber FFF device (or apparatus) is used. The ability to localize the target agent within the FFF device facilitates manipulation of the agent within a single chamber. Spent or excess reagents, byproducts, buffers and the like are removed from the chamber without significant loss or degradation of the target agent(s). In some aspects, the FFF device comprises a plurality of chambers (e.g., 2-5), any subset of which may be in tandem and/or in parallel. Manipulation of more than one particular agent (or agent type) may be performed using parallel FFF chambers, although it may also be accomplished using a single chamber.

If a plurality of chambers are used, each fluidic chamber may be tailored for a specific function, whether isolation or concentration (e.g., DNA isolation), limited or complete digestion (e.g., restriction enzyme digestion), or labeling (e.g., labeling with one or more agent-specific probes or incorporation of labels). After each step, the agent is sent to the next chamber using fluid flow. A final chamber may be used to purify the agent from all other components and to prepare the agent for subsequent analysis (e.g., using a single molecule analysis system). Importantly, however, the invention envisions performing at least a subset and optionally all of these steps in a single FFF chamber. The systems and methods are scalable and therefore can be adapted to the amount and nature of the starting sample and the expected amount of target agent present.

The invention further relates in part to the use of centrifugation (e.g., of air samples) to separate physically bioaerosol components from unwanted background contaminants. More specifically, the invention embraces the use of, inter alia, buoyant density centrifugation or counterflow centrifugal elutriation (CCE) to separate components of a sample prior to entry into a fractionation device. Buoyant density centrifugation separates agents based on hydrodynamic size and buoyant density. It allows target agents to be separated from unwanted background components (e.g., dust and diesel particulates) as well as from other agents of same or different kind. Harvest and centrifugation of sample may be continuous, with agents harvested based on their location in a sedimentation gradient. Depending upon the resolution of the gradient, agents may be harvested together or they may be isolated from other components.

This collection and sorting system can be used in conjunction with a fractionation device and system. For example, spores, viruses and other biological material may be physically separated from each other, with each sample type being transferred from the centrifuge to an appropriate fractionation chamber for sample processing. Overall efficiency of sample processing is therefore improved by reducing or removing altogether interference from contaminants, and optionally by processing each sample in parallel optionally using protocols specific to each agent type. The proposed systems may also be automated.

Thus in one aspect, the invention provides a method for modifying an agent comprising providing a field flow fractionation channel, introducing an agent and at least one reagent capable of reacting with the agent into the field-flow fractionation channel, and maintaining the agent and the at least one reagent in the channel for a time, and under conditions, suitable to allow the at least one reagent to react with and modify the agent. The agent may be a nucleic acid of interest within a pathogen such as a bacterial spore. Thus, the spore is first introduced into the channel but a nucleic acid is ultimately retrieved from the channel following processing and then subsequently analyzed.

In another aspect, the invention provides method for modifying an agent comprising providing a channel having an upstream portion and a downstream portion, the channel defined at least by a first wall and a second wall closely spaced from the first wall, the channel constructed and arranged to transport carrier fluids containing the agent and at least one reagent capable of reacting with the agent from the upstream portion and toward the downstream portion between the first and second walls; flowing the carrier fluids containing the agent and the at least one reagent toward the downstream portion in laminar flow; allowing a transverse force to act on the carrier fluid and its contents, the transverse force adapted to move at least the agent toward the first wall; holding the agent at the first wall; and allowing the at least one reagent to react with and modify the agent in the channel.

A number of embodiments apply to these and other subsequent aspects of the invention. These will be recited once but it is to be understood that they apply equally to the various aspects of the invention.

Thus, in one embodiment, the carrier fluid containing the agent is introduced into the channel at a different time than the carrier fluid containing the at least one reagent. In another embodiment, holding the agent at the first wall comprises increasing a magnitude of the transverse force. In another embodiment, the method further comprises releasing the agent from the first wall by decreasing the magnitude of the transverse force.

In one embodiment, holding the agent at the first wall comprises stopping carrier fluid from flowing through the channel. In another embodiment, the method further comprises positioning the agent between the upstream and downstream portion of the channel by flowing fluid into the channel from both the downstream and the upstream portions.

In still another embodiment, the method further comprises removing the carrier fluid from the channel; and flowing an additional fluid into the channel, the additional fluid having a composition different than the carrier fluid removed from the channel.

The at least one reagent may be a lysing agent (i.e., a reagent that lyses the agent) or it may be a probe specific for the agent but it is not so limited.

In one embodiment, the method further comprises flowing an additional carrier fluid in the channel toward the downstream portion; and removing the agents from the channel with the additional carrier fluid.

In one embodiment, the method further comprises removal of the at least one reagent prior to analysis of the agent.

In one embodiment, the method further comprises providing a second channel having an upstream portion, a downstream portion, the second channel defined at least by a first wall and a second wall closely spaced from the first wall of the second channel, the second channel constructed and arranged to transport the additional carrier fluid from the upstream portion of the second channel and toward the downstream portion of the second channel while between the first and second walls of the second channel; flowing the additional carrier fluid toward the downstream portion of the second channel; allowing an additional transverse force to act on the fluid and its contents within the second channel, the additional transverse force adapted to move the agent toward the first wall of the second channel; holding the agent at the first wall of the second channel; and modifying the agent in the second channel.

In another embodiment, allowing the transverse force to act on the agent comprises flowing a cross flow fluid toward the first wall, the cross flow fluid adapted to move the agent toward the first wall. In a related embodiment, the first wall is a first porous wall.

In one embodiment, flowing the cross flow fluid comprises flowing the cross flow fluid into the channel from an inlet in the upstream portion and removing portions of the cross flow fluid and the carrier fluid from the channel through the first wall. In a related embodiment, removing portions of the cross flow fluid and the carrier fluid from the channel through the first wall comprises removing remaining and unused reagent.

In one embodiment, the downstream portion of the channel has a smaller cross sectional area than the upstream portion.

In one embodiment, the method further comprises flowing each of the carrier fluid and the cross flow fluid through a separate passageway in an introduction channel in the upstream portion of the channel, each passageway of the introduction channel adapted to direct fluid toward the downstream portion of the channel. In another embodiment, the method further comprises flowing each of the carrier fluid and the cross flow fluid in the upstream portion of the channel such that the carrier fluid and the cross flow fluid are layered between the closely spaced walls when in the upstream portion of the channel. In a related embodiment, flowing each of the carrier fluid and the cross flow fluids in the upstream portion of the channel comprises flowing each of the carrier and cross flow fluids into the channel through a corresponding manifold in the channel.

In yet another embodiment, the second wall is porous and further flowing the cross flow fluid comprises flowing the cross flow fluid into the channel through the second porous wall.

In one embodiment, the downstream portion and the upstream portion of the channel each have a similar cross sectional area.

In one embodiment, allowing a transverse force to act on the agent comprises applying a centrifugal force, a gravitational force, an acoustic force, a magnetic force or a thermal force to move the agent toward the first wall. In another embodiment, allowing a transverse force to act on the agent comprises applying an electric field between the first and second walls, the electric field adapted to move the agent toward the first wall.

In one embodiment, the agent comprises a plurality of agents and further wherein flowing the carrier fluid comprises flowing carrier fluid such that the plurality of agents is fractionated along the first wall. In a related embodiment, a transverse force moves larger agents toward the first wall faster than the transverse force moves smaller agents toward the first wall.

In another embodiment, the method further comprises varying and controlling temperature of the carrier fluid within the channel.

In one embodiment, the first wall comprises a semi-permeable membrane and a porous support structure, the semi-permeable membrane being removable from the channel.

In another embodiment, the second wall is spaced from the first wall by fewer than five hundred microns. In still another embodiment, the second wall is spaced from the first wall by fewer than two hundred microns.

In one embodiment, the agent comprises a plurality of agents, and the method further comprises separating agents within the carrier fluid based on hydrodynamic size and buoyant density prior to providing the carrier fluid to the channel.

In one embodiment, the agent is a polymer. In related embodiments, the polymer is a nucleic acid optionally selected from the group consisting of DNA or RNA. In other related embodiments, the polymer is a peptide or a polypeptide.

The agent may be a cell or a cell constituent such as a nucleic acid.

The agent may be a pathogen. The pathogen in turn may be a spore, a bacterium, a virus, a fungus, a parasite, or a mycobacterium.

In another aspect, the invention provides a method for modifying an agent comprising providing a carrier fluid containing agents and debris; removing debris from the carrier fluid based on hydrodynamic size and buoyant density; providing a channel having an upstream portion and a downstream portion, the channel defined at least by a first wall and a second wall closely spaced from the first wall, the channel constructed and arranged to transport the carrier fluid from the upstream portion and toward the downstream portion with the carrier fluid located between the first and second walls; providing the carrier fluid containing the agents to the channel near the upstream portion; flowing the carrier fluid toward the downstream portion in laminar flow; allowing a transverse force to act on the agents in the carrier fluid, the transverse force adapted to move the agent toward the first wall; and holding the agents at the first wall.

In another aspect, the invention provides a method for modifying an agent comprising providing a carrier fluid containing at least a first and a second agent; separating the first agent from the second agent based on hydrodynamic size and buoyant density; providing a channel having an upstream portion and a downstream portion, the channel defined at least by a first wall and a second wall closely spaced from the first wall, the channel constructed and arranged to transport the carrier fluid from the upstream portion and toward the downstream portion with the carrier fluid located between the first and second walls; providing a carrier fluid containing the first agent to the channel near the upstream portion; flowing the carrier fluid toward the downstream portion in laminar flow; allowing a transverse force to act on the first agent in the carrier fluid, the transverse force adapted to move the first agent toward the first wall; and holding the first agent on the first wall. In one embodiment, the second agent is discarded. In another embodiment, the second agent is provided to a separate channel in a carrier fluid.

In yet another aspect, the invention provides a system for modifying an agent comprising a plurality of chambers, each of the chambers comprising a channel with an upstream portion and a downstream portion, the channel defined at least in part by a first wall and a second wall closely spaced from the first wall, the channel constructed and arranged to transport a carrier fluid containing a agent toward the downstream portion with the carrier fluid located between the first and second walls; an apparatus adapted to allow a transverse force to act on the agent in the channel to move the agent toward the first wall; and a controller adapted to adjust a flow rate of fluid in the channel and to adjust a magnitude of the transverse force to hold the agent on the first wall; and a fluidic connection adapted to transport carrier fluid containing the agent from a first of the plurality of chambers to a second of the plurality of chambers.

In still another aspect, the invention provides a reconfigurable chamber for modifying an agent comprising a channel with an upstream portion and a downstream portion, the channel defined at least in part by a first wall and a second wall closely spaced from the first wall, the channel constructed and arranged to transport a carrier fluid containing an agent toward the downstream portion with the carrier fluid located between the first and second walls, wherein the first and second walls are adapted to be separated from one another by a spacer that defines a channel height between the first and second walls; a fluid inlet for introducing carrier fluid including the agent into the upstream portion of the channel; an apparatus adapted to allow a transverse force to act on the agent in the channel to move the agent toward the first wall; and a plurality of fluid outlets, each adapted to remove at least a portion of the carrier fluid from the channel and each spaced from the inlet to define a corresponding channel length; a plurality of spacers each adapted to be placed between the first wall and the second wall to define the channel height and each having a differently sized aperture that extends between the inlet and at least one of the outlets to define the channel length.

In a further aspect, the invention provides a chamber for modifying an agent comprising a housing; a channel in the housing, the channel having an upstream portion and a downstream portion and the channel being defined at least in part by a first wall and a second wall closely spaced from the first wall, the channel constructed and arranged to transport a carrier fluid containing the agent from the upstream portion and toward the downstream portion between the first and second walls; and a support adapted to provide support to the first wall; a cassette that includes the first wall and the support, the cassette being removable from the housing as a unit to facilitate replacement of the first wall; and an apparatus adapted to allow a transverse force to act on the agent in the channel to move the agent toward and hold the agent on the first wall.

In still another aspect, the invention provides a chamber for modifying an agent comprising a housing; a channel in the housing, the channel having an upstream portion and a downstream portion and the channel being defined at least by a first wall and a second wall closely spaced from the first wall, the channel constructed and arranged to transport a carrier fluid containing an agent from the upstream portion and toward the downstream portion between the first and second walls; and an apparatus adapted to allow a transverse force to act on the agent in the channel to move the agent toward and hold the agent at the first wall; and a temperature control adapted to maintain the carrier fluid at a desired temperature.

And in yet another aspect, the invention provides a chamber for modifying an agent comprising a channel in the housing, the channel having an upstream portion and a downstream portion and the channel being defined at least in part by a first porous wall and a second wall closely spaced from the first porous wall, the channel constructed and arranged to transport a carrier fluid containing an agent from the upstream portion and toward the downstream portion between the first and second walls; a carrier fluid inlet in the upstream portion of the channel; a cross flow fluid inlet in the upstream portion of the channel, the cross flow fluid inlet providing fluid communication to the channel for cross flow fluid that, when drawn through the first porous wall, allows a transverse force that acts on the agent by moving the agent toward the first porous wall; an introduction channel that provides fluid communication between the upstream portion of the channel and each of the carrier fluid inlet and the cross flow fluid inlet, the introduction channel adapted to introduce each of the carrier fluid and the cross flow fluid in the upstream portion of the channel such that the carrier fluid and the cross flow fluid are layered between the closely spaced walls when in the upstream portion of the channel.

These and other aspects of the invention, as well as various advantages and utilities, will be more apparent with reference to the detailed description of the preferred embodiments and to the accompanying drawings.

Each of the limitations of the invention can encompass various embodiments of the invention. It is, therefore, anticipated that each of the limitations of the invention involving any one element or combinations of elements can be included in each aspect of the invention. This invention is not limited in its application to the details of construction and the arrangement of components set forth in the following description or illustrated in the drawings. The invention is capable of other embodiments and of being practiced or of being carried out in various ways.

The phraseology and terminology used herein is for the purpose of description and should not be regarded as limiting. The use herein of “including”, “comprising”, “having”, “containing”, “involving”, and variations thereof, is meant to encompass the items listed thereafter and equivalents thereof as well as additional items.

### BRIEF DESCRIPTION OF THE FIGURES

The accompanying Figures are not intended to be drawn to scale. For purposes of clarity, not every component may be labeled in every Figure.

FIG. 1 is an exploded view of a chamber assembly, according to one embodiment.

FIG. 2 is a cross sectional view of the chamber of FIG. 1, in an assembled state.

FIG. 3 is a schematic diagram of a laminar flow velocity profile, as may be found in channels according to some embodiments of the invention.

FIG. 4 is a chamber having a pair of closely spaced, porous walls that define a channel.

FIG. 5 is a cylindrically shaped chamber including a cylindrically shaped channel.

FIG. 6 is a flow diagram showing a system comprising multiple chambers.

FIG. 7 is a view of a chamber having a removable cassette that includes a porous membrane and a supporting structure.

FIG. 8 is a cross sectional view of an embodiment that has a heat exchanger used to heat or cool a channel in the chamber.

FIG. 9 is a cross sectional view of a channel that has an inlet to promote laminar flow of fluid introduced into the channel.

FIG. 10 is a schematic of a process for separating target agents from debris and background contaminants in a sample using centrifugation.

FIG. 11 is a schematic of a buoyant density separation of components in a sample.

FIG. 12 is a schematic of a preparation process.

It is to be understood that the Figures are not required for enablement of the invention.

### DETAILED DESCRIPTION OF THE INVENTION

The invention provides modification of an agent in a fluidic fractionation device. Modification, as used herein, means a change to the agent or to the sample in which the agent is present. For example, modification can be isolation or purification of the agent from the sample in which it is present. Modification may be a chemical or enzymatic reaction on the agent. The range of modifications will depend on the nature of the agent. Virtually any modification that is performed on an agent can be accomplished in a single or multiple chamber fluidic fractionation device according to the invention.

Thus, in its broadest sense, the invention provides a method for performing a reaction on an agent in a fluidic fractionation device. A reaction, as used herein, is a covalent or non-covalent modification of an agent. A covalent modification means that a covalent bond is broken and/or formed. A non-covalent modification means any other type of modification. The reaction may be a chemical or enzymatic reaction. It may be performed on any agent or plurality of agents.

A fluidic fractionation device includes one or more chamber each of which preferably contains one channel. The channel has opposed walls that are closely spaced to one another. As used herein, closely spaced means spaced at a distance that maintains laminar and parabolic flow. A carrier fluid containing one or more agents can be introduced to the channel and moved from an upstream portion to a downstream portion of the channel, between the closely spaced walls. Similarly, carrier fluid(s) carrying one or more reagents that act on the agent(s) and optionally modify them can also be introduced into the channel. In a fluidic fractionation channel, flow that is further from the opposed, closely spaced walls (and agents located therein) moves downstream more rapidly than flow that is near the walls. Thus, the flow will tend to spread out agents in a continuum between the upstream and downstream portions of the channel during operation. In important embodiments, a fluidic fractionation channel is an field flow fractionation (FFF) channel and it contains the same attributes as described herein. FFF is a flow-based technique which utilizes an unobstructed and thin fluid in a channel that may be only several hundred micrometers thick. FFF is described in U.S. Pat. Nos. 4,147,621; 4,214,981; 4,250,026; 4,737,268; 4,830,756; 4,894,146; 5,039,426; 5,141,651; 5,156,039; and 5,193,688, among others.

The agents introduced into the channel can be fractionated as they pass there through. As used herein, the term ‘fractionation’ refers to the separation of agents based on a physical and/or chemical characteristic of the agent. Such characteristics include but are not limited to volume, molecular weight, hydrodynamic size, buoyant density, charge and the like.

In some but not all embodiments, it can be beneficial to fractionate agents. For example, agents of a particular size, such as polymers of a particular length, may be of particular interest. Fractionation can allow the agents of particular size to be separated from other components of a sample, including other agents of differing size. Subsequent analysis can then be performed on the agents so fractionated. While fractionation can be useful in some embodiments, it is to be appreciated that not all embodiments of the invention include fractionation. That is, some embodiments simply use a flow field fractionation channel to house and perform a reaction on an agent.

The fluidic fractionation chamber may be constructed to allow a transverse force to act on the fluid and/or components (including agents contained therein). The transverse force may be used to direct agents in the fluid toward one of the opposing walls. If the transverse force acts on the agents in a selective manner, such as by moving larger agents more rapidly than smaller agents, then the larger agents will be moved toward the slower flow near the wall more rapidly than the smaller agents. This can result in the agents being organized along the wall selectively based on size, or whichever characteristic the transverse force selectively acts upon. The transverse force also can be used to hold agents at a wall, optionally in a monolayer. At various times during processing, the magnitude of the transverse force can be reduced or the force can be removed all together to allow the agents to move downstream in a carrier fluid. The same or additional carrier fluid can be passed through the channel to flow the agents out of the outlet, optionally maintaining physical separation of fractionated agents. In some embodiments, portions of the flow containing the target agents can be diverted from flow containing remaining agents and other sample or channel components for example using valves and the like.

If the transverse force is generated by a second independent flow perpendicular to the main flow, the technique is flow field flow fractionation (FlFFF). If both walls are porous (e.g., comprised at least of a semi-permeable membrane and in some instances also of a porous support such as a frit), this is referred to as symmetric FlFFF. If only one wall is porous (with the other wall being impermeable), this is referred to as asymmetrical FlFFF. The perpendicular flow field, optionally termed cross flow, may be created within the channel itself and driven by a pressure differential across the height of the channel (e.g., between the opposing closely spaced walls). In either case, the semi-permeable membrane allows fluid and waste to pass through the wall while preventing the passage of target agents.

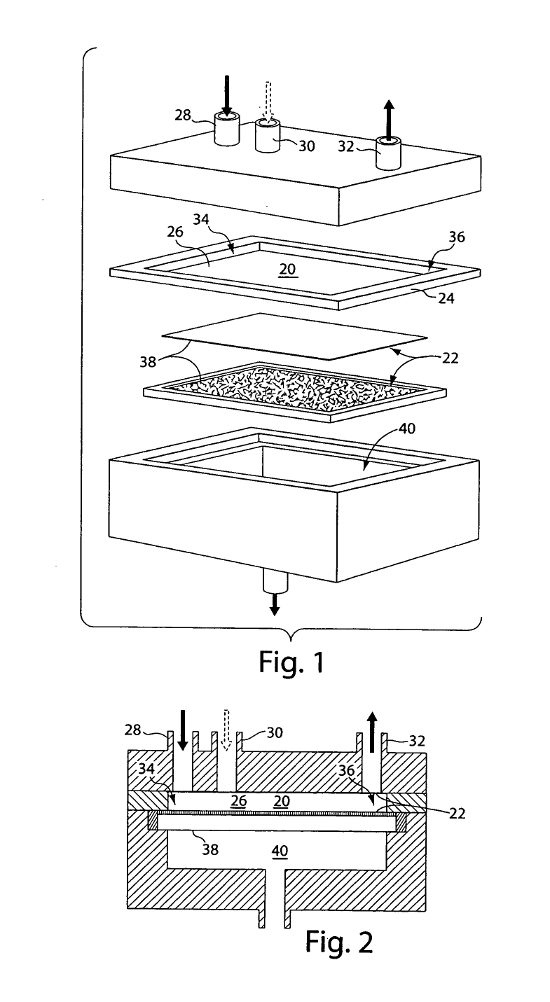

Turning to the Figures, FIG. 1 shows an exploded view of a chamber according to one embodiment. The chamber includes an elongated channel 20 defined at least by a pair of opposed, closely spaced walls 22, one or both of which may be a porous wall 38. When assembled, a spacer 24 is sandwiched between the opposed walls. The spacer has an aperture 26 that defines the remaining walls of the channel. The spacer also has a specific thickness that defines how closely spaced the first and second opposed walls will be when the chamber is assembled. A first inlet 28 for providing carrier fluid to the channel, and optionally a second inlet 30 for providing another fluid (e.g., another carrier fluid), such as a cross flow fluid to the channel, are in fluid communication with preferably the upstream portion 34 of the channel. An outlet 32 for removing fluid from the channel is in fluid communication with preferably the downstream portion 36 of the channel.

FIGS. 1 and 2 show one embodiment of the chamber. In this embodiment, the chamber 2 is divided into two compartments by a semi-permeable membrane, a frit and a series of gaskets and O-rings. The first compartment is the channel and the second compartment is the waste area, as described herein. The semi-permeable membrane and the frit comprise the first porous wall described above. As illustrated, the chamber includes O-rings and gaskets to prevent fluid from leaking outside of the chamber and around the porous wall between the channel and waste area, thereby minimizing agent loss. It is to be appreciated that the construction shown in FIGS. 1 and 2 is only one possible construction, as the invention is not limited to what is illustrated in these Figures.

Various fluids including fluids carrying sample (including agents), buffers and reagents including enzymes, co-factors, substrates, probes and the like, can be introduced into the chamber, optionally at either the first and/or second inlet, and in some embodiments at the outlet. This is usually accomplished via a series of pumps, ports and valves connected to appropriate containers that house the fluids being introduced into the chamber. It is also to be understood that the chamber may comprise more than two inlets and outlets depending on user requirements.

The chamber may have one, two or more porous walls. The porous wall may be comprised of at least a semi-permeable membrane and/or a porous solid support. As used herein, a semi-permeable membrane is a membrane that allows the passage of some but not all contents of the channel, optionally into a waste compartment. Usually the semi-permeable membrane is defined by a molecular weight cut-off which indicates the demarcation between moieties that can traverse the membrane and those that cannot. For example, if the agent is unsheared and optionally digested genomic DNA, then the molecular weight cut off will be greater than if the agent is a small peptide. Thus, the molecular weight cut off may be 10 kD, 20 kD, 30 kD, 40 kD, 50 kD, 60 kD, 70 kD, 80 kD, 90 kD, 100 kD, 120 kD, 140 kD, 150 kD, 160 kD, 180 kD, 200 kD, 300 kD, or greater. Additionally, the membrane is preferably made of a material to which agents do not bind non-specifically in order to minimize agent loss and maximize agent yield. The membrane may be dialysis membrane (which generally has a lower molecular weight cut off) although more preferably it is ultrafiltration membrane. It will be understood that the membrane of choice will depend on the agents being modified and/or the reagents used to modify the agents.

The porous wall 38 therefore may be a semi-permeable membrane that optionally is positioned adjacent to a supporting structure, such as a frit. A frit is porous structure, typically made of fused glass or metal particles, that is porous yet firm. On an opposite side of the frit, a waste area 40 exists to collect fluid that is passed through the porous wall and eventually removed from the channel and chamber altogether.

FIG. 2 shows a chamber, like that of FIG. 1, in an assembled state. The Figure represents a chamber 20 with a porous wall 38. A carrier fluid optionally containing a plurality of agents, optionally of different sizes, is introduced into the channel through the first inlet 28. Simultaneously, a buffer fluid may be introduced into the chamber through the second inlet 30. A carrier fluid as used herein generally contains an agent or a reagent. A buffer fluid as used herein prior to entry into the channel generally does not contain agents or reagents. However it is to be understood that fluids and their components may mix within the channel such that there may be no demarcation between carrier and buffer fluids (as well as between a first and subsequent fluids introduced into the channel). The carrier fluid and buffer fluid flow toward the downstream portion 36 of the channel in laminar flow, where at least portions of the fluids are removed from the channel through the outlet 32. Additionally, at least some of the fluids are drawn through the porous wall and into the waste area 40, and then removed from the chamber. The fluid drawn through the porous wall can also move agents toward the porous wall. The cross flow fluid can also hold the agents at the porous wall as the sample and buffer fluids pass through and out of the channel, either through the outlet or the waste area. The agents that are held at the porous wall can then be modified within the channel, through the various techniques described herein.

With any of the fractionation devices embraced by the invention, the target agent may be held at least one wall of the channel. As used herein, the term “held at the wall” refers to positioning of one or more agents at or near at least one wall of the channel. An agent that is held at a wall does not move upstream or downstream significantly. However, agents that are held at the wall are not required to be completely stationary, as they may experience some localized movement. By way of example, a polymer that is held at the porous wall may experience some coiling or uncoiling, similar to that experienced by a polymer residing in a quiescent pool of fluid; however, the polymer will not experience significant movement upstream or downstream in the channel while it is held at the wall. It is to be understood that an agent that is held at a wall as used herein is not permanently, covalently or irreversibly bound to the wall. Rather it is simply positioned at or near the wall as a way of retaining the agent in the sample. The agent may be in physical contact with the wall, but this is not absolutely necessary. As an example, holding the agent at the wall may be appropriate while other components are removed from the chamber, while the agent is being acted upon by one or more reagents, while the environment about the agent is altered, and/or while fluid within the channel to be replaced by another fluid having different characteristics.

Various techniques can be used to hold agents at the wall. In some embodiments, moving the agent to the flow that is next to the wall, such that the agent resides in slow or non-moving flow near the wall, may be enough to hold the agent at the wall. A transverse force can be used to hold the agents at the wall. In some embodiments, this can include increasing the magnitude of the transverse force, applying the transverse force for a longer duration, and/or applying the transverse force after a flow rate of the carrier fluid through the channel (i.e., the main flow) is reduced.

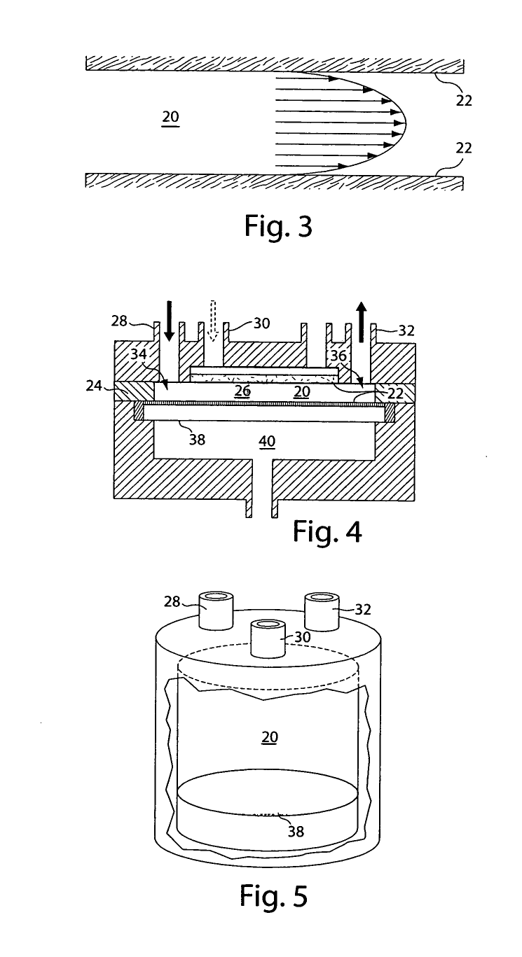

Fluid moving toward the downstream portion typically moves in laminar flow, which allows agents introduced to the channel in a bolus to spread along the length of the channel. This is referred to as the main flow within the channel. Laminar flow is characterized by streamlines that run parallel to one another as they move downstream. Laminar flow is to be distinguished from turbulent flow which comprises random fluid movement. Internal laminar flow, as found in the channel, can be characterized by a parabolic velocity profile between the opposed, closely spaced walls 22, as represented in FIG. 3. In such a velocity profile, flow that is closer to the opposed walls (and any agents located therein) moves slower than flow that is further from the opposed walls and thus, generally, more central in the channel. In this regard, agents more centrally located in the channel move downstream more rapidly than those near the walls. Such a velocity profile can result in a monolayer of agents at a wall when a transverse force is applied across the channel to move the agents toward the wall. As used herein, “monolayer” denotes that the agents are positioned at a wall in a substantially non-overlapping manner, thereby making agents accessible to fluid and reagents passing through the channel. Aggregation, condensation and entanglement (e.g., in the case of polymers) are thereby minimized, and uniform exposure of agents to channel conditions and components is maximized.

As mentioned above, many embodiments embrace a chamber that allows a transverse force to exist across the channel where it acts on a target agent. As used herein, the term “transverse force” denotes a force that can move agents toward one or optionally both of the opposing walls. Some transverse forces may act indirectly on the agents by first acting on the fluid that surrounds them, such as transverse forces associated with a cross flow fluid. Other transverse forces can act directly on the agents themselves, such as forces associated with an electric field or gravitational or centrifugal forces. Also, while some transverse forces act selectively based on a physical and/or chemical characteristic of the agents (such as for example size) to help fractionate, not all transverse forces are required to act in such a manner. The transverse force can act to move agents in other directions as well as or instead of toward the first wall. For instance, the transverse force can also direct agents either upstream or downstream. In this respect, the transverse force does not have to act exclusively to direct agents toward a wall of the channel.

The transverse force in the embodiment of FIGS. 1 and 2 is provided by a cross flow of fluid passed from the channel through a porous wall and into the waste area. The cross flow typically has a lower flow rate than the fluid moving toward the downstream portion of the channel (i.e., the main flow), so as not to adversely impact the parabolic velocity profile of the main flow. The cross flow rate may be one thousandth, on hundredth, one tenth, one fifth, or one half of the main flow rate. Alternatively, it may be 60%, 70%, 80%, or 90% of the main flow rate. The opposed walls, which are closely spaced, particularly when considered in view of the distance between the upstream portion and the downstream portion, allow this to be accomplished. As mentioned above, the transverse force can move agents at selective rates according to for example size. As an example, hydrodynamic size allows larger agents move more rapidly than smaller agents. Hydrodynamic size refers to cross sectional area of the agent, projected in the direction of the transverse force. As the cross flow fluid is moved across an agent, it applies a pressure force on the upstream surface of the agent. The pressure force is applied across the area of the agent projected in a plane perpendicular to the direction of the transverse force. Agents that are larger will have a larger projected area and thus a larger force will act upon them, which can result in forces that move larger agents faster toward the porous wall, all else constant. It is to be appreciated that factors other than hydrodynamic size can be used to selectively move agents toward the porous wall, as the invention is not limited in this regard. Also, as described above, the transverse force is not required to act selectively on the agents, but rather can move each of the agents toward the porous wall at a similar rate.

Cross flow can be created within the channel through various means. As shown in FIGS. 1 and 2, the channel can have multiple fluid inlets. The first inlet can be used to introduce one or more carrier fluids containing a sample, an agent, a probe, a reagent, and the like, in any combination, to the channel at an appropriate time. The second inlet can be used to provide a continuous flow of buffer solution through the channel, such fluid can be used as a cross flow fluid or an additional fluid that is used to replace fluid that resides within the channel. It is to be appreciated that the relative flow rates between the first and the second inlet can vary, from and between all of the fluid being introduced through the first inlet to all of the fluid being introduced through the second inlet. Additionally, any fluid introduced to the channel can be introduced through either inlet. In some embodiments, there may be more or fewer inlets, as chambers are not limited to only two inlets as illustrated in each of FIGS. 1 and 2. Additionally, the chambers are not limited to only one outlet and may contain 2, 3 or more.

Transverse forces can be created with mechanisms other than cross flow. For example, other forces transversely applied across a laminar flow include but are not limited to electrochemical, gravitational, centrifugal forces, acoustic, magnetic and thermal forces. By way of example, an electrical field may be created between the opposed walls. Here, the field can be used to move agents with a particular charge (positive or negative) toward one of the opposing walls. Agents with a greater charge, all else constant, can be moved more rapidly by the field. In other embodiments, the channel may be rotated about an axis such that centrifugal forces act on the agents in the channel. In such embodiments, molecules that have a smaller hydrodynamic size can move toward the porous wall more rapidly. Rotating the channel causes agents of different volumes and molecular weight to move toward the wall at different rates to allow fractionation to occur.

Fluid can be moved through the channel through various mechanisms. In some embodiments, a pressure is applied at each of the inlets that pushes the fluids through the channel. Alternately, vacuum pressure can be applied at the outlet and/or from the waste chamber to help draw fluid through the channel. In some embodiments, both positive pressure at the inlets and vacuum pressure at the outlet can drive fluid flow through the device. The invention is not limited to any particular configuration for driving fluid through the chamber.

The channel can have a reduced cross sectional area at points closer to the downstream portion. For instance, the chamber shown in FIG. 1 can have a spacer with an aperture that defines a channel with a width that narrows downstream. In an embodiment where fluid is removed along a length of the channel (e.g., through a porous wall), the narrowing channel can be used to maintain a substantially constant velocity along the length of the channel. Otherwise, fluid removed through the porous wall could provide the remaining fluid with a greater amount of space, which could slow the fluid as it moves toward the downstream portion. In some embodiments, particularly those that direct fluid through the channel by pressure provided at the inlets alone, the narrowing channel can cause the cross flow fluid to pass through the porous wall, thus creating the transverse force.

In one illustrative embodiment, the channel is constructed such that buffer fluid is introduced to the channel along a length of one of the opposed walls. For example, FIG. 4 shows one such embodiment where both of the opposed, closely spaced walls 22 include porous sections. Here buffer solution is provided to the channel 20 along a part of or the entire length of the upper porous wall. In this manner, the channel can have a constant cross sectional area between the upstream 34 and downstream 36 portions as the amount of fluid entering the channel at points between the upstream and downstream portions through the upper wall can be equal to the amount of fluid being removed from the lower porous walls.

Channels can be formed in different shapes and sizes. By way of example, the channel may have length of about 26 cm, a width of about 3 cm at the widest point, and a height between the opposed walls of about 500-1000 microns. However, other embodiments can have different characteristics, as aspects of the invention are not limited in this regard. In some embodiments, the length of the channel is increased so that the fluid can be resident in the channel for a longer duration for a given flow rate. A longer channel may be desirable for some types of agents that take longer to fractionate. Additionally, the average width of the channel can be altered from that shown in FIGS. 1 and 2. An increased width can increase the cross sectional area available to fluid passing through the channel, such that a greater amount of fluid/sample can be processed in the same amount of time. Additionally, the distance between the closely spaced walls can be modified as necessary to accommodate different sized agents, agents that fractionate at different rates, different channel throughput rates, and the like, as aspects of the present invention are not limited in this regard.

Channel dimensions may be changed by replacing the spacer within the chamber. As in the embodiments of FIGS. 1 and 2, the spacer has an aperture that defines the width and length of the channel. By replacing the spacer with one having a different sized aperture, the channel width and length can be altered. Some embodiments can have multiple channel outlets to accommodate the different channel lengths. In such embodiments, outlets that are not used in a particular assay can be stoppered or plugged. In still other embodiments, each of the available outlets can be used during a particular process.

The channel height, or equivalently, the distance between the closely spaced walls can also be altered by replacing the spacer in some embodiments. As shown, the thickness of the spacer, when compressed between the opposed walls, defines the channel height. In some embodiments, the channel has a height of fewer than 1000 microns, although heights greater than 1000 microns are possible. The height may be at least 750 microns, at least 500 microns, at least 400 microns, at least 300 microns, at least 200 microns or at least 100 microns, but other heights are possible. Heights including and between 50-500 microns are typical.

Although the Figures show chambers with substantially rectangular channels, other channel shapes are also envisioned. By way of example, chambers may include channels formed of circular apertures in a spacer, like that shown in FIG. 5. Here the inlets and the outlet are on opposed sides of the circle, although other configurations are possible. Other chambers can be constructed to allow rotation about an axis, so as to create centrifugal forces as transverse forces. In another embodiment, hollow fibers can be used as fluidic chambers, allowing for the miniaturization of the system on to a microfluidic chip. In another embodiment, the shape of the reaction channel and/or the waste area can be altered to suit a particular fluid flow within each volume. Mechanical methods to agitate the system, such as gentle shaking or incorporating a magnetic stirrer into the system, can be added to a chamber if required for the desired preparative step in different embodiments.

The chambers can be constructed of different types of materials and from different components. The housings, like those shown in the embodiments of FIGS. 1 and 2, can be made out of two separate components that sandwich the spacer, although other constructions are possible. The illustrated embodiment has a housing made out of a biocompatible material such as polyetheretherketone (PEEK), although other materials can be used. In another embodiments, the housing could be formed from more than two components. The entire housing, in another embodiment, can be formed from only one piece. In another embodiment, either one or both components are made of a thermoconductive material such as titanium, aluminum or stainless steel to allow for rapid heating and cooling of the chamber. If the latter two materials are used, the surface which forms the internal chamber would preferably have an applied film such as a ceramic or a polymer to make the container biocompatible. In another embodiment, the whole chamber can be made of ceramic, which has sufficient thermoconductivity and is biologically inert.

Generally, each of the fluids introduced into the channel will serve a purpose such as introducing a sample, an agent (or a plurality of agents), one or more reagents, a buffer (for example of different pH, temperature and the like), etc. into the channel. The fluid and its components may act on the agent or it may simply wash the agent. It may also move the agent out of the channel and/or wash the channel thereafter in preparation for a new sample and/or agent.

Agents do not have to be held at the porous wall as they are being modified. By way of example, the agent may be able to move from the wall once the environment about the agent has been altered. For example, the agent may be held at one of the opposing walls to prevent it from flowing downstream as additional fluid is introduced into the channel, such as additional fluid that contains a reagent. Once the additional fluid with reagent is in the channel, the flow through the channel can be stopped. Additionally, the transverse force can be reduced or removed thereby allowing reagent to act on the agent.

Additional fluid can be introduced to the channel to end the modification of the agent. For instance, reagents can be removed by the channel by flowing additional fluid that lacks reagents into the channel while the agent is held against one of the opposing walls. The additional fluid may flush the reagents through the porous wall and into the waste area while retaining the agent in the channel, in some embodiments. It is to be appreciated that fluid resident in the channel can be removed from either the outlet or by passing the fluid through the porous wall, in certain embodiments. However, if fluid is to be removed through the outlet, the transverse force may need to be reapplied if the agents are to be held against the wall while the fluid is removed from the channel.

The device may consist of a single chamber. The contents and conditions within the channel may be changed at particular time intervals in order to perform a series of reactions, washes and the like on a sample and the agents contained therein. For example, an agent can be held at a wall in a chamber and manipulated by changing conditions in the channel. After the agent has been modified a first time, the conditions in the channel can be changed again to modify the agent a second time. In some embodiments, this is accomplished by replacing the initial carrier fluid in the channel with a first additional fluid to modify the agent the first time, and then again by a second additional fluid to modify the agent a second time. Alternatively, additional reagents or reaction components may be introduced into the chamber. It is to be understood that there is no limit to the number of modifications that can be performed on an agent in a given channel. Generally however the modified agent is analyzed following exit from the channel and chamber.

In some embodiments, it can be beneficial to move the agents to a different channel and/or chamber for subsequent modifications. This may be particularly beneficial where channels and/or chambers are optimized for specific modifications, as discussed herein. Thus, the device may consist of a plurality of channels and/or chambers (i.e., more than one but less than an infinite number, and preferably less than 1000, less than 100, less than 10, or less than 5). The plurality of channels and/or chambers may be oriented in parallel and/or in tandem (i.e., in series). If in tandem, each may be configured to perform one or more reactions or modifications in an overall process. In some embodiments, an agent is modified one or more times in the channel of a first chamber, and is then moved from the first channel by a carrier fluid to a second channel in the first or a second chamber. The agent is then manipulated one or more additional times when in the second channel. Moving the agent from one chamber to another can allow chambers to be optimized for particular types of modifications. Chambers in tandem may be more preferable where fluid flow and temperature changes are required throughout a process. It is to be understood therefore that one chamber may contain one or more channels and such channels may or may not share common fluid reservoir tanks, waste compartments, vacuums, pressurizers, temperature controls, etc.

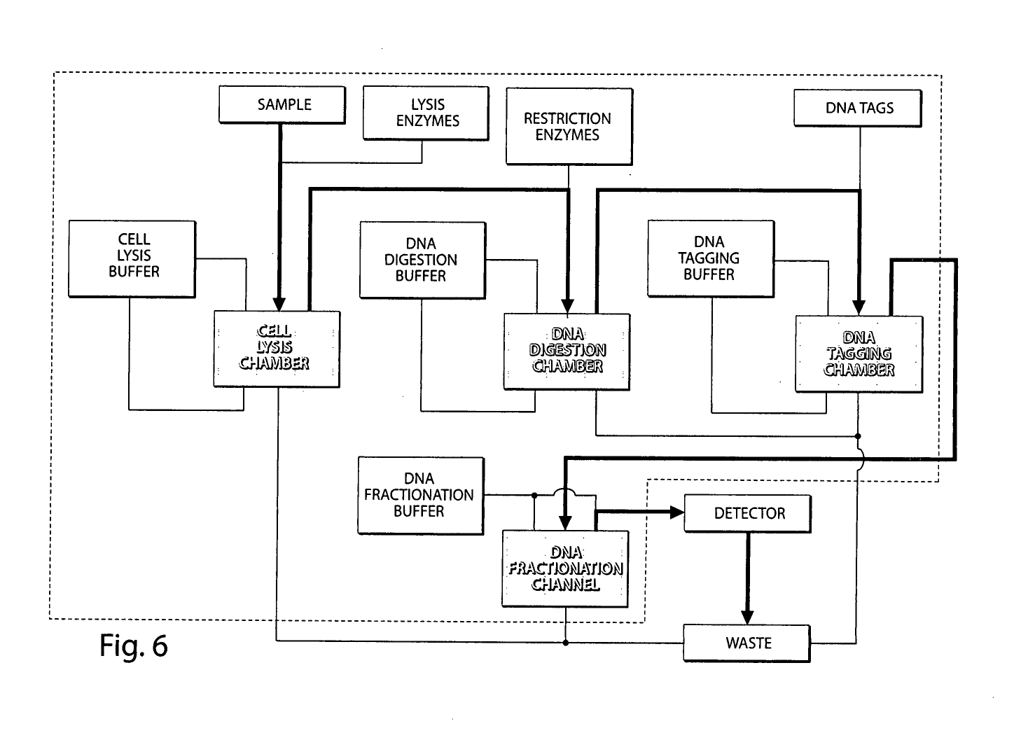

FIG. 6 illustrates a simple system layout of multiple chambers for the preparation of DNA in detection and identification of possible pathogens. Modification may include lysis of the pathogen, DNA isolation, DNA fractionation and DNA labeling. Importantly, the methods and systems of the invention allow for modification of polymers such as nucleic acids with substantially little or no fragmentation. The outline encompasses the components of the system, with each modular chamber being shaded. The arrows represent the flow path of the sample as it proceeds through the system, processed at the different chambers, and ultimately detected by a detection system such as but not limited to GeneEngine™ or Trilogy™ detection systems. The chambers are connected in series using tubing commonly used for liquid chromatography, such as ones composed of PEEK. In other embodiments, other biocompatible components and/or methodologies can be used to connect the chambers in series. Tubing also connects each chamber to the necessary buffers and reagent reservoirs required for the desired preparative step. Fluid flow is controlled by pumps and other similar devices, while fluid direction (i.e., control of ports) is performed by valves. These devices are similar to those used in liquid chromatography devices.

Due to the modular nature of the system, the number of chambers required to obtain the desired final compound for analysis can be altered depending on the user's needs. For example, an additional chamber could be added into the system if separation of bacteria from viruses is required prior to other process steps. In another embodiment, the chambers could be connected in parallel. Taking the example of separation of bacteria and viruses further, the invention contemplates a parallel system that allows each sample to be processed by different fluidic pathways simultaneously. In another embodiment, other fractionation techniques can be utilized for each process step. For example, electrical transverse force could be used to separate DNA released from bacteria.

It can be advantageous to position agents together in a channel for various reasons. For instance, once agents have been modified it can be advantageous to position them together in a bolus within the carrier fluid in a channel prior to moving them to another chamber or to ultimately analyzing them apart from any chamber. If desired, fractionation may occur anew in a subsequent chamber. To accomplish this, flow can be introduced to the channel simultaneously from each of the upstream and downstream portions (e.g., from the inlet and outlet). The flows will move toward a common, optionally central portion of the channel and exit through the porous wall, moving agents concurrently. Once the agents have been grouped together, the flow from the downstream portion can be stopped, such that the bolus of agents can be moved toward the outlet and out of the chamber.

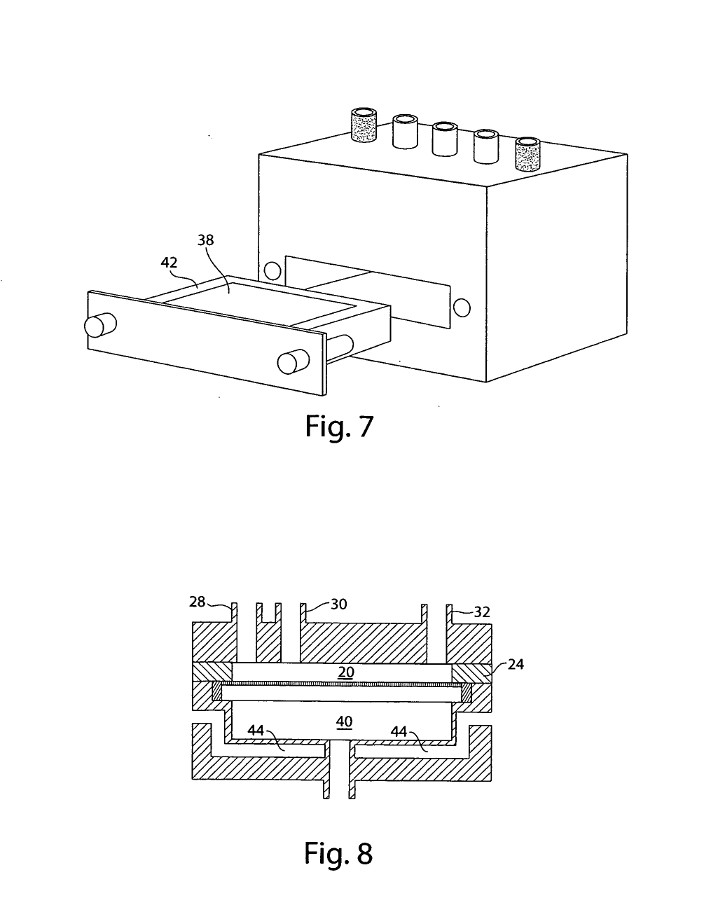

The invention also embraces a variety of field flow fractionation chambers. As mentioned previously, the chamber can be configured to allow for facile insertion and replacement of one or both of the opposing walls. In one embodiment shown in FIGS. 1 and 2, the chamber assembly is held together using a series of screws or other similar means. Replacement of the membrane is performed by disassembling the chamber. The number of screws required can vary, depending on the quantity required to hold the assembly together, and to maintain an appropriate seal. In one embodiment the chamber is formed of two separate stainless steel pieces which are screwed together, analogous to a mini-extruder. The porous wall, reinforced along its edges for strength, is sealed between the two pieces again by a series of gaskets and O-rings, and a frit for membrane support. In another embodiment as shown in FIG. 7, the porous wall is placed in a cassette structure 42 along with a supporting structure, such as a frit, and the entire chamber remains one solid piece. The membrane cassette is sealed within the compartment using a pressure gasket system, again with screws or some other physical device. The cassette can be readily removed from the chamber such that the wall can be cleaned or replaced for subsequent use. In another embodiment, the entire module is disposable.

In another embodiment, a spacer can replaced readily in a chamber to alter the distance between the upstream and downstream portions of the channel and/or the spacing between the opposed walls. Still other embodiments include an inlet that promotes laminar flow of fluid introduced into the channel. In some of these embodiments, the inlet has passageways that each directs one of a plurality of fluids toward the downstream portion of the channel to promote laminar flow.

As discussed herein, the chamber can have mechanisms to maintain or change fluid temperature. In one embodiment, a heater is incorporated into the chamber such that the agent can be maintained or brought to a specific temperature in the channel. FIG. 8 shows one embodiment of a chamber that includes a heat exchanger. A passageway 44 runs through the chamber adjacent to the channel. Fluid can be passed through the passageway to heat the channel, or to remove heat from the channel as may be desired. In such embodiments, it may be desirable to make the chamber from thermally conductive material, at least between the channel and the passageways. In other embodiments, other heating and/or cooling mechanisms can be used, such as resistance heaters, as aspects or the invention are not limited in this regard.

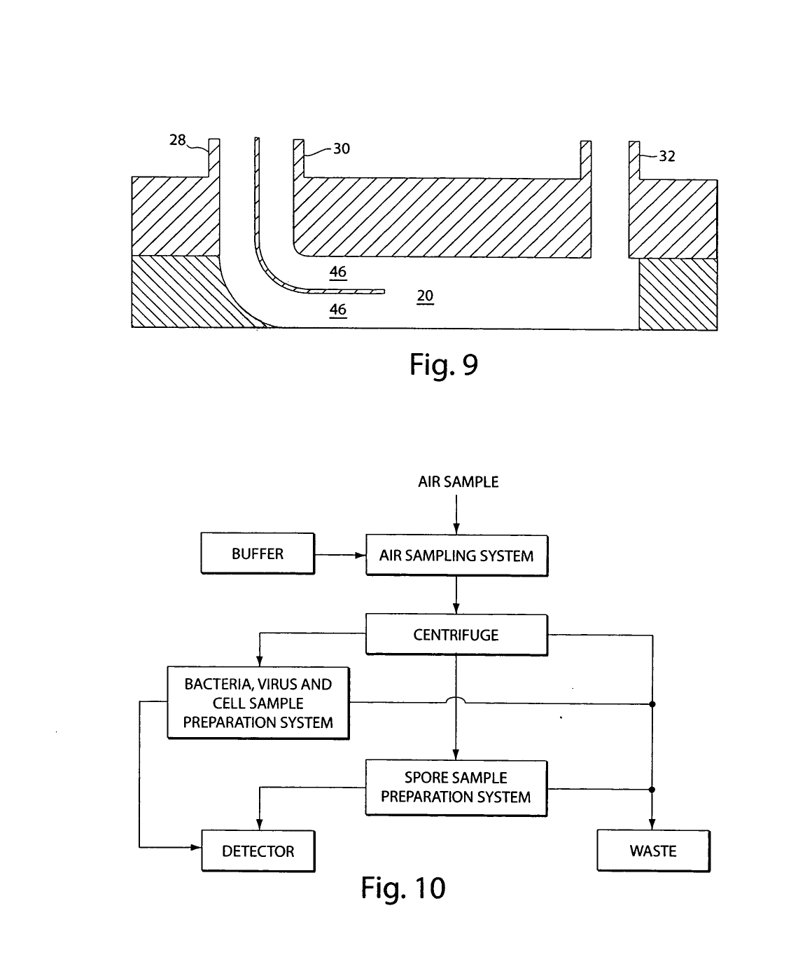

The inlets to the channel in some embodiments include features to promote laminar flow. An example of such a device is shown in FIG. 9. Here, each inlet includes a passageway that directs fluid toward the downstream portion to promote laminar flow. That is, fluid injected into the channel is turned within the passageway as necessary such that when the fluid exits the passageway, it is flowing parallel to other fluid within the channel. In this manner, the fluid does not impinge on any other fluid residing in the channel. This can reduce eddies and other features which can cause turbulence within the channel. Although the illustrated example involves only a pair of passageways, other embodiments can have more passageways, although embodiments will typically have a number of passageways equal to the number of inlets.

Some embodiments include features to help place agents or reagents at appropriate positions when they are introduced to the channel. By way of example, the device shown in FIG. 10 includes a manifold 46 connected to each of the first and second inlets. The manifold can introduce multiple fluids into the channel as layers. In this regard, fluid can be placed at a desired vertical position by introducing it to the channel through a particular inlet and manifold. This can prove particularly useful in distributing reagent to areas within a channel. For example, the reagent can be introduced into a top layer within the channel such that a transverse force drive the layer down over agents that lie in a lower layer or that lie in a monolayer at the lower wall of the channel. In other embodiments, agents can be introduced through a manifold such that each of the agents are placed similarly within the parabolic velocity profile of fluid flowing through the channel. In this sense, each of the agents will initially be moving downstream at similar velocities. Although FIG. 10 shows an embodiment with a pair of inlets and corresponding manifolds, there is no limit to the number of manifolds that can be used in a given embodiment. Additionally, although the manifolds are shown to be similar in size to one another, other embodiments may differ in this respect. In some embodiments, in can prove beneficial to have manifolds with different heights (where height is taken in a direction between the closely spaced walls of the channel). Still, in some other embodiments, the manifolds may not extend the entire width of a channel, as aspects of the present invention are not limited in this respect.

Samples can be derived from virtually any source known or suspected to contain an agent of interest. Samples can be of solid, liquid or gaseous nature. They may be purified but usually are not. Different samples can be collected from different environments and prepared in the same manner by using the appropriate collecting device.

The samples to be tested can be a biological or bodily sample such as a tissue biopsy, urine, sputum, semen, stool, saliva and the like. The invention further contemplates preparation and analysis of samples that may be biowarfare targets. Air, liquids and solids that will come into contact with the greatest number of people are most likely to be biowarfare targets. Samples to be tested for the presence of such agents may be taken from an indoor or outdoor environment. Such biowarfare sampling can occur continuously, although this may not be necessary in every application. For example, in an airport setting, it may only be necessary to harvest randomly a sample near or around select baggage. In other instances, it may be necessary to continually monitor (and thus sample the environment). These instances may occur in “heightened alert” states. In some important embodiments, the sample is tested for the presence of a pathogen. Examples include samples to be tested for the presence of a pathogenic substances such as but not limited to food pathogens, water-borne pathogens, and aerosolized pathogens.

Liquid samples can be taken from public water supplies, water reservoirs, lakes, rivers, wells, springs, and commercially available beverages. Solids such as food (including baby food and formula), money (including paper and coin currencies), public transportation tokens, books, and the like can also be sampled via swipe, wipe or swab testing and placing the swipe, wipe or swab in a liquid for dissolution of any agents attached thereto. Based on the size of the swipe or swab and the volume of the corresponding liquid it must be placed in for agent dissolution, it may or may not be necessary to concentrate such liquid sample prior to further manipulation.

Air samples can be tested for the presence of normally airborne substances as well as aerosolized (or weaponized) chemicals or biologics that are not normally airborne. Air samples can be taken from a variety of places suspected of being biowarfare targets including public places such as airports, hotels, office buildings, government facilities, and public transportation vehicles such as buses, trains, airplanes, and the like.

The choice of air sampling instruments is dependent on user requirements, and those of ordinary skill in the art will be able to identify the appropriate instrument for a particular application. Various air sampling devices are currently commercially available. As an example, BioAerosol Concentrator manufactures an air sampler having a size of 3.5 cubic inches. Other companies that manufacture air sampling devices include International pbi S.pA. (making a device that aspirates 1 cubic meter is 10 minutes, or 1 cubic meter in 6 minutes, or 1 cubic meter in 3 minutes), Meso Systems, Sceptor Industries, Inc., and Anderson. Moreover, techniques for air sampling are described in J. P. Lodge, Jr. Methods of Air Sampling and Analysis, Third Edition, Lewis Publishers, Inc. (Dec. 31, 1988) ISBN 0873711416.

According to one embodiment of the invention, particulates less than 10 μm in diameter may be collected by the air sampler onto a filter system. In another embodiment, the particulates are impacted directly into a solvent. However since collection in this instance is based on hydrodynamic size, the collected particulates from the air sample will consist of the desired bioaerosol, as well as unwanted contaminants such as dust and diesel particulates. Preferably these contaminants should be removed prior to further preparation and analysis of the sample and agents contained therein. Accordingly, the invention provides in part methods for physically separating sample components sample prior to or after sample entry into the field flow fractionation device.

FIG. 10 is a schematic of a system layout to illustrate the sequence of events that may be used to prepare a bioaerosol for analysis. The Figure represents one embodiment of the system. As an example, consider a sample that is a bioaerosol and a target agent that is a bacterial spore or the DNA contained therein. The Figure demonstrates the flow path for a bioaerosol as it proceeds through the collection and sample preparation system. The spores are separated from the other components of the bioaerosol sample and the spore DNA can be prepared in a separate sample preparation system, such as a field flow fractionation device. The number of sample preparation systems can be altered depending on user requirements.

An appropriate buffer is used to remove the air particulates from the filter used to capture the sample. The solvent containing the sample is then transferred to a centrifuge. In one embodiment, the solvent used to remove the particles off of the filter is the same solution used to fractionate the sample by centrifugation. In another embodiment, a minimal volume of buffer is used to solubilize and transfer the sample particulates to the centrifuge, where they are introduced into a second solvent suitable for centrifugation.

Centrifuge technology is known and the choice of centrifuge is dictated by user requirements. In one embodiment, the sample is transferred into a disposable container within the centrifuge, which can be replaced for each air sample. In another embodiment, the centrifuge is reuseable. This latter example generally requires a solution to clean the instrument between air samples. Centrifuge volume can also vary depending on the air sample size. The air sample is transferred into the centrifuge for density gradient centrifugation, which involves spinning the sample in a suitable solvent for a given time under the required amount of g-forces. In one embodiment, a solvent such as Percoll™ is used, which establishes a density gradient during the sample centrifugation process. In another embodiment, the density gradient is carefully established prior to introducing the sample into the centrifuge.

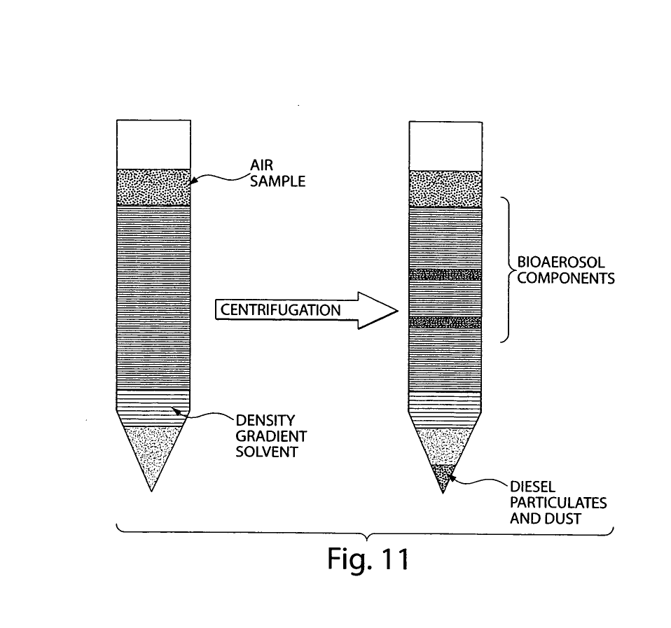

Once the appropriate centrifugal force is applied to the air sample, the individual particulates contained in the air sample separate into distinct bands due to differences in buoyant density (FIG. 11). Particulates such as dust and diesel particulates have a higher density than the bioaerosol. As a result, these contaminants are spun to the bottom of the centrifuge container. The isolated and purified components that make up the bioaerosol such as bacteria, cells and spores, are carefully removed from the centrifuge and delivered to the appropriate sample preparation system for further processing. In FIG. 10, the spores of the bioaerosol are separated from the other biological components and are sent to the preparation system tailored to prepare spore DNA as efficiently as possible. The remaining bioaerosol components are delivered to a separate preparation system. In other embodiments, more than one centrifugation stage is used with different centrifugation solvents, resulting in a greater degree of separation (i.e., greater resolution) between the various air sample components and the contaminants. These centrifugation steps can be performed by separate centrifuge devices in series, or by a single centrifuge device that is reused. The latter approach would require a system that would allow the removal and addition of solvents without disrupting the sample in question. The fluidic chambers required for DNA sample preparation are described herein.

The processing steps of the invention generally comprise the use of one or more reagents (i.e., at least one reagent) that acts on or reacts with and thereby modifies a target agent. At least one reagent however is less than an infinite number of reagents as used herein and more commonly represents less than 1000, less than 100, less than 50, less than 20, less than 10 or less than 5. The nature of the reagents will vary depending on the processing step being performed with such reagent. The reagent may be a lysing agent (e.g., a detergent such as but not limited to deoxycholate), a labeling agent or probe (e.g., a sequence-specific nucleic acid probe), an enzyme (e.g., a nuclease such as a restriction endonuclease), an enzyme co-factor, a stabilizer (e.g., an anti-oxidant), and the like. One of ordinary skill in the art can envision other reagents to be used in the invention. Although the agent can be modified through those techniques mentioned above, it is to be appreciated that other techniques can also be used to modify the agent.

Additionally, the fluids used in the invention may contain other components such as buffering compounds (e.g., TRIS), chelating compounds (e.g., EDTA), ions (e.g., monovalent, divalent or trivalent cations or anions), salts, and the like.

By way of example, a fluid may contain a lysing agent that lyses cellular agents (e.g., mammalian cells or pathogens such as bacteria, viruses and the like) in the channel, thereby releasing cellular contents, such as nucleic acids, into the channel.

The invention is not limited in the nature of the agent being modified, manipulated, detected or analyzed (i.e., the target agent). These agents include but are not limited to cells and cell components (e.g., proteins and nucleic acids), chemicals and the like. These agents may be biohazardous agents as described in greater detail herein. Target agents may be naturally occurring or non-naturally occurring, and this includes agents synthesized ex vivo but released into a natural environment. As described herein, the methods and systems of the invention can be used to modify one or more agents concurrently, simultaneously or consecutively. A plurality of agents is more than one and less than an infinite number. It includes less than 10¹⁰, less than 10⁹, less than 10⁸, less than 10⁹, less than 10⁷, less than 10⁶, less than 10⁵, less than 10⁴, less than 5000, less than 1000, less than 500, less 100, less than 50, less than 25, less than 10 and less than 5, as well as every integer therebetween as if explicitly recited herein.

The conditions, temperature, buffers and reagents of the chamber will vary depending on the particular type of modification being performed.

The invention can be applied to the detection and optionally identification and/or quantification of any agent, but most preferably rare agents which would otherwise be costly to detect. One example of such agents is biohazardous or biowarfare agents. These agents can be biological or chemical in nature. Biological biowarfare agents can be classified broadly as pathogens (including spores thereof) or toxins. As used herein, a pathogen (including a spore thereof) is an agent capable of entering a subject such as a human and infecting that subject. Examples of pathogens include infectious agents such bacteria, viruses, fungi, parasites, mycobacteria and the like. Prions may also be considered pathogens to the extent they are thought to be the transmitting agent for CJD and like diseases. As used herein, a toxin is a pathogen-derived agent that causes disease and often death in a subject without also causing an infection. It derives from pathogens and so may be harvested therefrom. Alternatively, it may be synthesized apart from pathogen sources. Biologicals may be weaponized (i.e., aerosolized) for maximum spread.

CDC Category A agents include Bacillus anthracis (otherwise known as anthrax), Clostridium botulinum and its toxin (causative agent for botulism), Yersinia pestis (causative agent for the plague), variola major (causative agent for small pox), Francisella tularensis (causative agent for tularemia), and viral hemorrhagic fever causing agents such as filoviruses Ebola and Marburg and arenaviruses such as Lassa, Machupo and Junin.

CDC Category B agents include Brucellosis (Brucella species), epsilon toxin of Clostridium perfringens, food safety threats such as Salmonella species, E. coli and Shigella, Glanders (Burkholderia mallei), Melioidosis (Burkholderia pseudomallei), Psittacosis (Chlamydia psittaci), Q fever (Coxiella burnetii), ricin toxin (from Ricinus communis—castor beans), Staphylococcal enterotoxin B, Typhus fever (Rickettsia prowazekii), viral encephalitis (alphaviruses, e.g., Venezuelan equine encephalitis, eastern equine encephalitis, western equine encephalitis), and water safety threats such as e.g., Vibrio cholerae, Cryptosporidium parvum.

CDC Category C agents include emerging infectious diseases such as Nipah virus and hantavirus.

Further examples of bacteria that can be used as biohazards include Gonorrhea, Staphylococcus spp., Streptococcus spp. such as Streptococcus pneumoniae, Syphilis, Pseudomonas spp., Clostridium difficile, Legionella spp., Pneumococcus spp., Haemophilus spp. (e.g., Haemophilus influenzae), Klebsiella spp., Enterobacter spp., Citrobacter spp., Neisseria spp. (e.g., N. meningitidis, N. gonorrhoeae), Shigella spp., Salmonella spp., Listeria spp. (e.g., L. monocytogenes), Pasteurella spp. (e.g., Pasteurella multocida), Streptobacillus spp., Spirillum spp., Treponema spp. (e.g., Treponema pallidum), Actinomyces spp. (e.g., Actinomyces israelli), Borrelia spp., Corynebacterium spp., Nocardia spp., Gardnerella spp. (e.g., Gardnerella vaginalis), Campylobacter spp., Spirochaeta spp., Proteus spp., and Bacteriodes spp.

Further examples of viruses that can be used as biohazards include Hepatitis virus A, B and C, West Nile virus, poliovirus, rhinovirus, HIV, Herpes simplex virus 1 and 2 (including encephalitis, neonatal and genital forms), human papilloma virus, cytomegalovirus, Epstein Barr virus, Hepatitis virus A, B and C, rotavirus, adenovirus, influenza virus including influenza A virus, respiratory syncytial virus, varicella-zoster virus, small pox, monkey pox and SARS virus.

Further examples of fungi that can be used as biohazards include candidiasis, ringworm, histoplasmosis, blastomycosis, paracoccidioidomycosis, crytococcosis, aspergillosis, chromomycosis, mycetoma, pseudallescheriasis, and tinea versicolor.

Further examples of parasites that can be used as biohazards include both protozoa and nematodes such as amebiasis, Trypanosoma cruzi, Fascioliasis (e.g., Facioloa hepatica), Leishmaniasis, Plasmodium (e.g., P. falciparum, P. knowlesi, P. malariae,) Onchocerciasis, Paragonimiasis, Trypanosoma brucei, Pneumocystis (e.g., Pneumocystis carinii), Trichomonas vaginalis, Taenia, Hymenolepsis (e.g., Hymenolepsis nana), Echinococcus, Schistosomiasis (e.g., Schistosoma mansoni), neurocysticercosis, Necator americanus, and Trichuris trichuria, Giardia.

Further examples of mycobacteria that can be used as biohazards include M. tuberculosis or M. leprae.

Examples of toxins include abrin, ricin and strychnine. Further examples of toxins include toxins produced by Corynebacterium diphtheriae (diphtheria), Bordetella pertussis (whooping cough), Vibrio cholerae (cholera), Bacillus anthracis (anthrax), Clostridium botulinum (botulism), Clostridium tetani (tetanus), and enterohemorrhagic Escherichia coli (bloody diarrhea and hemolytic uremic syndrome), Staphylococcus aureus alpha toxin, Shiga toxin (ST), cytotoxic necrotizing factor type 1 (CNF1), E. coli heat-stable toxin (ST), botulinum, tetanus neurotoxins, S. aureus toxic shock syndrome toxin (TSST), Aeromonas hydrophila aerolysin, Clostridium perfringens perfringolysin O, E. coli hemolysin, Listeria monocytogenes listeriolysin O, Streptococcus pneumoniae pneumolysin, Streptococcus pyogenes streptolysine O, Pseudomonas aeruginosa exotoxin A, E. coli DNF, E. coli LT, E. coli CLDT, E. coli EAST, Bacillus anthracis edema factor, Bordetella pertussis dermonecrotic toxin, Clostridium botulinum C2 toxin, C. botulinum C3 toxin, Clostridium difficile toxin A, and C. difficile toxin B.

Examples of chemicals that can be detected include arsenic, arsine, benzene, blister agents/vesicants, blood agents, bromine, borombenzylcyanide, chlorine, choking/lung/pulmonary agents, cyanide, distilled mustard, fentanyls and other opioids, mercury, mustard gas, nerve agents, nitrogen mustard, organic solvents, paraquat, phosgene, phosphine, sarin, sesqui mustard, stibine, sulfur mustard, warfarin, tabun, and the like.

The foregoing lists of infections are not intended to be exhaustive but rather exemplary.

It may be necessary to disrupt pathogen cell walls, cell membranes or viral envelopes, in some embodiments. This can enrich for agents to be detected. Disruption can be accomplished by any number of means including mechanical, electrical, osmotic, pressure, and the like. In one embodiment, the sample is exposed to an acoustic conditioning method.

As an example, microorganisms can be disrupted using a non-contact, reagent-less focused acoustic technology, developed at Covaris Inc., Woburn, Mass., and described in U.S. Pat. No. 6,719,449, issued Apr. 13, 2004. This procedure enables higher recoveries and better reproducibility than conventional, physical contact systems such as liquid nitrogen grinding, bead beating, sonicators (low frequency, unfocused, standing waves) and polytron-type homogenizers. In addition, it does not require special reagents.

The agent may be a polymer. A “polymer” as used herein is a compound having a linear backbone to which monomers are linked together by linkages. The polymer is made up of a plurality of individual monomers. An individual monomer as used herein is the smallest building block that can be linked directly or indirectly to other building blocks (or monomers) to form a polymer. At a minimum, the polymer contains at least two linked monomers. The particular type of monomer will depend upon the type of polymer being analyzed. The polymer may be a nucleic acid, a protein, a peptide, a carbohydrate, an oligo- or polysaccharide, a lipid, etc. The polymer may be naturally occurring but it is not so limited.

In some embodiments, the polymer is capable of being bound to or by sequence- or structure-specific probes, wherein the sequence or structure recognized and bound by the probe is unique to that polymer or to a region of the polymer. It is possible to use a given probe for two or more polymers if a polymer is recognized by two or more probes, provided that the combination of probes is still specific for only a given polymer. The sample in some instances can be analyzed as is without harvest and isolation of polymers contained therein.

In some embodiments, the method can be used to detect a plurality of different polymers in a sample.

Although the polymer may be linearized or stretched prior to analysis, this is not necessary if the ultimate detection system used is capable of analyzing both stretched and condensed polymers. As used herein, stretching of the polymer means that the polymer is provided in a substantially linear extended form rather than a compacted, coiled and/or folded form. Stretching the polymer prior to analysis may be accomplished using the FFF device, various embodiments of the detection system, and the like. These configurations are not required if the target polymer can be analyzed in a compacted form.

In some important embodiments, the agents are polymers such as nucleic acids. The term “nucleic acid” refers to multiple linked nucleotides (i.e., molecules comprising a sugar (e.g., ribose or deoxyribose) linked to an exchangeable organic base, which is either a pyrimidine (e.g., cytosine (C), thymidine (T) or uracil (U)) or a purine (e.g., adenine (A) or guanine (G)). “Nucleic acid” and “nucleic acid molecule” are used interchangeably and refer to oligoribonucleotides as well as oligodeoxyribonucleotides. The terms shall also include polynucleosides (i.e., a polynucleotide minus a phosphate) and any other organic base containing nucleic acid. The organic bases include adenine, uracil, guanine, thymine, cytosine and inosine.

In important embodiments, the nucleic acid is DNA or RNA. DNA includes genomic DNA (such as nuclear DNA and mitochondrial DNA), as well as in some instances complementary DNA (cDNA). RNA includes messenger RNA (mRNA), miRNA, and the like. The nucleic acid may be naturally or non-naturally occurring. Non-naturally occurring nucleic acids include but are not limited to bacterial artificial chromosomes (BACs) and yeast artificial chromosomes (YACs). Harvest and isolation of nucleic acids are routinely performed in the art and suitable methods can be found in standard molecular biology textbooks. (See, for example, Maniatis' Handbook of Molecular Biology.)

Preferably, prior amplification using techniques such as polymerase chain reaction (PCR) are not necessary. Accordingly, the polymer may be a non in vitro amplified nucleic acid. As used herein, a “non in vitro amplified nucleic acid” refers to a nucleic acid that has not been amplified in vitro using techniques such as polymerase chain reaction or recombinant DNA methods. A non in vitro amplified nucleic acid may however be a nucleic acid that is amplified in vivo (in the biological sample from which it was harvested) as a natural consequence of the development of the cells in vivo. This means that the non in vitro nucleic acid may be one which is amplified in vivo as part of locus amplification, which is commonly observed in some cell types as a result of mutation or cancer development.

As used herein with respect to linked units of a polymer including a nucleic acid, “linked” or “linkage” means two entities bound to one another by any physicochemical means. Any linkage known to those of ordinary skill in the art, covalent or non-covalent, is embraced. Natural linkages, which are those ordinarily found in nature connecting for example the individual units of a particular nucleic acid, are most common. Natural linkages include, for instance, amide, ester and thioester linkages. The individual units of a nucleic acid analyzed by the methods of the invention may be linked, however, by synthetic or modified linkages. Nucleic acids where the units are linked by covalent bonds will be most common but those that include hydrogen bonded units are also embraced by the invention. It is to be understood that all possibilities regarding nucleic acids apply equally to nucleic acid targets and nucleic acid probes, as discussed herein.

The nucleic acids may be double-stranded, although in some embodiments the nucleic acid targets are denatured and presented in a single-stranded form. This can be accomplished by modulating the environment of a double-stranded nucleic acid including singly or in combination increasing temperature, decreasing salt concentration, and the like. Methods of denaturing nucleic acids are known in the art.

The target nucleic acids commonly have a phosphodiester backbone because this backbone is most common in vivo. However, they are not so limited. Backbone modifications are known in the art. One of ordinary skill in the art is capable of preparing such nucleic acids without undue experimentation. The probes, if nucleic acid in nature, can also have backbone modifications such as those described herein.

Thus the nucleic acids may be heterogeneous in backbone composition thereby containing any possible combination of nucleic acid units linked together such as peptide nucleic acids (which have amino acid linkages with nucleic acid bases, and which are discussed in greater detail herein). In some embodiments, the nucleic acids are homogeneous in backbone composition.

The methods of the invention in part may be used to analyze agents using probes that recognize and specifically bind to an agent. Binding of a probe to an agent may indicate the presence and location of a target site in the target agent, or it may simply indicate the presence of the agent, depending on user requirements. As used herein, a target agent that is bound by a probe is “labeled” with the probe and/or its detectable label.

As used herein, a probe is a molecule or compound that binds preferentially to the agent of interest (i.e., it has a greater affinity for the agent of interest than for other compounds). Its affinity for the agent of interest may be at least 2-fold, at least 5-fold, at least 10-fold, or more than its affinity for another compound. Probes with the greatest differential affinity are preferred in most embodiments.

The probes can be of any nature including but not limited to nucleic acid (e.g., aptamers), peptide, carbohydrate, lipid, and the like. A nucleic acid based probe such as an oligonucleotide can be used to recognize and bind DNA or RNA. The nucleic acid based probe can be DNA, RNA, LNA or PNA, although it is not so limited. It can also be a combination of one or more of these elements and/or can comprise other nucleic acid mimics. With the advent of aptamer technology, it is possible to use nucleic acid based probes in order to recognize and bind a variety of compounds, including peptides and carbohydrates, in a structurally, and thus sequence, specific manner. Other probes for nucleic acid targets include but are not limited to sequence-specific major and minor groove binders and intercalators, nucleic acid binding peptides or proteins, etc.

As used herein a “peptide” is a polymer of amino acids connected preferably but not solely with peptide bonds. The probe may be an antibody or an antibody fragment. Antibodies include IgG, IgA, IgM, IgE, IgD as well as antibody variants such as single chain antibodies. Antibody fragments contain an antigen-binding site and thus include but are not limited to Fab and F(ab)₂ fragments.

The methods provided herein involve the use of probes that bind to the target polymer in a sequence-specific manner. “Sequence-specific” when used in the context of a nucleic acid means that the probe recognizes a particular linear (or in some instances quasi-linear) arrangement of nucleotides or derivatives thereof. In some embodiments, the probes are “polymer-specific” meaning that they bind specifically to a particular polymer, possibly by virtue of a particular sequence or structure unique to that polymer.

In some instances, nucleic acid probes will form at least a Watson-Crick bond with a target nucleic acid. In other instances, the nucleic acid probe can form a Hoogsteen bond with the target nucleic acid, thereby forming a triplex. A nucleic acid probe that binds by Hoogsteen binding enters the major groove of a nucleic acid polymer and hybridizes with the bases located there. Examples of these latter probes include molecules that recognize and bind to the minor and major grooves of nucleic acids (e.g., some forms of antibiotics). In some embodiments, the nucleic acid probes can form both Watson-Crick and Hoogsteen bonds with the nucleic acid polymer. Bis PNA probes, for instance, are capable of both Watson-Crick and Hoogsteen binding to a nucleic acid.

The length of probe can also determine the specificity of binding. The energetic cost of a single mismatch between the probe and the nucleic acid polymer is relatively higher for shorter sequences than for longer ones. Therefore, hybridization of smaller nucleic acid probes is more specific than is hybridization of longer nucleic acid probes because the longer probes can embrace mismatches and still continue to bind to the polymer depending on the conditions. One potential limitation to the use of shorter probes however is their inherently lower stability at a given temperature and salt concentration. In order to avoid this latter limitation, bis PNA probes can be used to bind shorter sequences with sufficient hybrid stability. Longer probes are desirable when unique gene-specific sequences are being detected.

Notwithstanding these provisos, the nucleic acid probes of the invention can be any length ranging from at least 4 nucleotides to in excess of 1000 nucleotides. In preferred embodiments, the probes are 5-100 nucleotides in length, more preferably between 5-25 nucleotides in length, and even more preferably 5-12 nucleotides in length. The length of the probe can be any length of nucleotides between and including the ranges listed herein, as if each and every length was explicitly recited herein. Thus, the length may be at least 5 nucleotides, at least 10 nucleotides, at least 15 nucleotides, at least 20 nucleotides, or at least 25 nucleotides, or more, in length. The length may range from at least 4, at least 5, at least 6, at least 7, at least 8, at least 9, at least 10, at least 12, at least 15, at least 20, at least 25, at least 50, at least 75, at least 100, at least 150, at least 200, at least 250, at least 500, or more nucleotides (including every integer therebetween as if explicitly recited herein).

It should be understood that not all residues of the probe need hybridize to complementary residues in the nucleic acid target. For example, the probe may be 50 residues in length, yet only 25 of those residues hybridize to the nucleic acid target. Preferably, the residues that hybridize are contiguous with each other.

The probes are preferably single-stranded, but they are not so limited. For example, when the probe is a bis PNA it can adopt a secondary structure with the nucleic acid polymer resulting in a triple helix conformation, with one region of the bis PNA clamp forming Hoogsteen bonds with the backbone of the polymer and another region of the bis PNA clamp forming Watson-Crick bonds with the nucleotide bases of the polymer.

The nucleic acid probe hybridizes to a complementary sequence within the nucleic acid polymer. The specificity of binding can be manipulated based on the hybridization conditions. For example, salt concentration and temperature can be modulated in order to vary the range of sequences recognized by the nucleic acid probes. Those of ordinary skill in the art will be able to determine optimum conditions for a desired specificity.

In some embodiments, the probes may be molecular beacons. When not bound to their targets, the molecular beacon probes form a hairpin structure and do not emit fluorescence since one end of the molecular beacon is a quencher molecule. However, when bound to their targets, the fluorescent and quenching ends of the probe are sufficiently separated so that the fluorescent end can now emit.

The probes may be nucleic acids, as described herein, or nucleic acid derivatives. As used herein, a “nucleic acid derivative” is a non-naturally occurring nucleic acid or a unit thereof. Nucleic acid derivatives may contain non-naturally occurring elements such as non-naturally occurring nucleotides and non-naturally occurring backbone linkages. These include substituted purines and pyrimidines such as C-5 propyne modified bases, 5-methylcytosine, 2-aminopurine, 2-amino-6-chloropurine, 2,6-diaminopurine, hypoxanthine, 2-thiouracil and pseudoisocytosine. Other such modifications are well known to those of skill in the art.

The nucleic acid derivatives may also encompass substitutions or modifications, such as in the bases and/or sugars. For example, they include nucleic acids having backbone sugars which are covalently attached to low molecular weight organic groups other than a hydroxyl group at the 3′ position and other than a phosphate group at the 5′ position. Thus, modified nucleic acids may include a 2′-O-alkylated ribose group. In addition, modified nucleic acids may include sugars such as arabinose instead of ribose.

The probes if comprising nucleic acid components can be stabilized in part by the use of backbone modifications. The invention intends to embrace, in addition to the peptide and locked nucleic acids discussed herein, the use of the other backbone modifications such as but not limited to phosphorothioate linkages, phosphodiester modified nucleic acids, combinations of phosphodiester and phosphorothioate nucleic acid, methylphosphonate, alkylphosphonates, phosphate esters, alkylphosphonothioates, phosphoramidates, carbamates, carbonates, phosphate triesters, acetamidates, carboxymethyl esters, methylphosphorothioate, phosphorodithioate, p-ethoxy, and combinations thereof.

In some embodiments, the probe is a nucleic acid that is a peptide nucleic acid (PNA), a bis PNA clamp, a pseudocomplementary PNA, a locked nucleic acid (LNA), DNA, RNA, or co-nucleic acids of the above such as DNA-LNA co-nucleic acids. siRNA or miRNA or RNAi molecules can be similarly used.

In some embodiments, the probe is a peptide nucleic acid (PNA), a bis PNA clamp, a locked nucleic acid (LNA), a ssPNA, a pseudocomplementary PNA (pcPNA), a two-armed PNA (as described in co-pending U.S. patent application having Ser. No. 10/421,644 and publication number US 2003-0215864 A1 and published Nov. 20, 2003, and PCT application having serial number PCT/US03/12480 and publication number WO 03/091455 A1 and published Nov. 6, 2003, filed on Apr. 23, 2003), or co-polymers thereof (e.g., a DNA-LNA co-polymer).

PNAs are DNA analogs having their phosphate backbone replaced with 2-aminoethyl glycine residues linked to nucleotide bases through glycine amino nitrogen and methylenecarbonyl linkers. PNAs can bind to both DNA and RNA targets by Watson-Crick base pairing, and in so doing form stronger hybrids than would be possible with DNA or RNA based probes.

PNAs are synthesized from monomers connected by a peptide bond (Nielsen, P. E. et al. Peptide Nucleic Acids, Protocols and Applications, Norfolk: Horizon Scientific Press, p. 1-19 (1999)). They can be built with standard solid phase peptide synthesis technology. PNA chemistry and synthesis allows for inclusion of amino acids and polypeptide sequences in the PNA design. For example, lysine residues can be used to introduce positive charges in the PNA backbone. All chemical approaches available for the modifications of amino acid side chains are directly applicable to PNAs.

PNA has a charge-neutral backbone, and this attribute leads to fast hybridization rates of PNA to DNA (Nielsen, P. E. et al. Peptide Nucleic Acids, Protocols and Applications, Norfolk: Horizon Scientific Press, p. 1-19 (1999)). The hybridization rate can be further increased by introducing positive charges in the PNA structure, such as in the PNA backbone or by addition of amino acids with positively charged side chains (e.g., lysines). PNA can form a stable hybrid with DNA molecule. The stability of such a hybrid is essentially independent of the ionic strength of its environment (Orum, H. et al., BioTechniques 19(3):472-480 (1995)), most probably due to the uncharged nature of PNAs. This provides PNAs with the versatility of being used in vivo or in vitro. However, the rate of hybridization of PNAs that include positive charges is dependent on ionic strength, and thus is lower in the presence of salt.

Several types of PNA designs exist, and these include single strand PNA (ssPNA), bis PNA and pseudocomplementary PNA (pcPNA).

The structure of PNA/DNA complex depends on the particular PNA and its sequence. Single stranded PNA (ssPNA) binds to single stranded DNA (ssDNA) preferably in antiparallel orientation (i.e., with the N-terminus of the ssPNA aligned with the 3′ terminus of the ssDNA) and with a Watson-Crick pairing. PNA also can bind to DNA with a Hoogsteen base pairing, and thereby forms triplexes with double stranded DNA (dsDNA) (Wittung, P. et al., Biochemistry 36:7973 (1997)).

Single strand PNA is the simplest of the PNA molecules. This PNA form interacts with nucleic acids to form a hybrid duplex via Watson-Crick base pairing. The duplex has different spatial structure and higher stability than dsDNA (Nielsen, P. E. et al. Peptide Nucleic Acids Protocols and Applications, Norfolk: Horizon Scientific Press, p. 1-19 (1999)). However, when different concentration ratios are used and/or in presence of complimentary DNA strand, PNA/DNA/PNA or PNA/DNA/DNA triplexes can also be formed (Wittung, P. et al., Biochemistry 36:7973 (1997)). The formation of duplexes or triplexes additionally depends upon the sequence of the PNA. Thymine-rich homopyrimidine ssPNA forms PNA/DNA/PNA triplexes with dsDNA targets where one PNA strand is involved in Watson-Crick antiparallel pairing and the other is involved in parallel Hoogsteen pairing. Cytosine-rich homopyrimidine ssPNA preferably binds through Hoogsteen pairing to dsDNA forming a PNA/DNA/DNA triplex. If the ssPNA sequence is mixed, it invades the dsDNA target, displaces the DNA strand, and forms a Watson-Crick duplex. Polypurine ssPNA also forms triplex PNA/DNA/PNA with reversed Hoogsteen pairing.

Bis PNA includes two strands connected with a flexible linker. One strand is designed to hybridize with DNA by a classic Watson-Crick pairing, and the second is designed to hybridize with a Hoogsteen pairing. The target sequence can be short (e.g., 8 bp), but the bis PNA/DNA complex is still stable as it forms a hybrid with twice as many (e.g., a 16 bp) base pairings overall. The bis PNA structure further increases specificity of their binding. As an example, binding to an 8 bp site with a probe having a single base mismatch results in a total of 14 bp rather than 16 bp.

Preferably, bis PNAs have homopyrimidine sequences, and even more preferably, cytosines are protonated to form a Hoogsteen pair to a guanosine. Therefore, bis PNA with thymines and cytosines is capable of hybridization to DNA only at pH below 6.5. The first restriction—homopyrimidine sequence only—is inherent to the mode of bis PNA binding. Pseudoisocytosine (J) can be used in the Hoogsteen strand instead of cytosine to allow its hybridization through a broad pH range (Kuhn, H., J. Mol. Biol. 286:1337-1345 1999)).

Bis PNAs have multiple modes of binding to nucleic acids (Hansen, G. I. et al., J. Mol. Biol. 307(1):67-74 (2001)). One isomer includes two bis PNA molecules instead of one. It is formed at higher bis PNA concentration and has a tendency to rearrange into the complex with a single bis PNA molecule. Other isomers differ in positioning of the linker around the target DNA strands. All the identified isomers still bind to the same binding site/target.

Pseudocomplementary PNA (pcPNA) (Izvolsky, K. I. et al., Biochemistry 10908-10913 (2000)) involves two single stranded PNAs added to dsDNA. One pcPNA strand is complementary to the target sequence, while the other is complementary to the displaced DNA strand. As the PNA/DNA duplex is more stable, the displaced DNA generally does not restore the dsDNA structure. The PNA/PNA duplex is more stable than the DNA/PNA duplex and the PNA components are self-complementary because they are designed against complementary DNA sequences. Hence, the added PNAs would rather hybridize to each other. To prevent the self-hybridization of pcPNA units, modified bases are used for their synthesis including 2,6-diamiopurine (D) instead of adenine and 2-thiouracil (^{S}U) instead of thymine. While D and ^{S}U are still capable of hybridization with T and A respectively, their self-hybridization is sterically prohibited.

Locked nucleic acid (LNA) molecules form hybrids with DNA, which are at least as stable as PNA/DNA hybrids (Braasch, D. A. et al., Chem & Biol. 8(1): 1-7(2001)). Therefore, LNA can be used just as PNA molecules would be. LNA binding efficiency can be increased in some embodiments by adding positive charges to it. LNAs have been reported to have increased binding affinity inherently.

Commercial nucleic acid synthesizers and standard phosphoramidite chemistry are used to make LNAs. Therefore, production of mixed LNA/DNA sequences is as simple as that of mixed PNA/peptide sequences. The stabilization effect of LNA monomers is not an additive effect. The monomer influences conformation of sugar rings of neighboring deoxynucleotides shifting them to more stable configurations (Nielsen, P. E. et al. Peptide Nucleic Acids Protocols and Applications, Norfolk: Horizon Scientific Press, p. 1-19 (1999)). Also, lesser number of LNA residues in the sequence dramatically improves accuracy of the synthesis. Naturally, most of biochemical approaches for nucleic acid conjugations are applicable to LNA/DNA constructs.

Other backbone modifications, particularly those relating to PNAs, include peptide and amino acid variations and modifications. Thus, the backbone constituents of PNAs may be peptide linkages, or alternatively, they may be non-peptide linkages. Examples include acetyl caps, amino spacers such as 8-amino-3,6-dioxaoctanoic acid (referred to herein as O-linkers), amino acids such as lysine (particularly useful if positive charges are desired in the PNA), and the like. Various PNA modifications are known and probes incorporating such modifications are commercially available from sources such as Boston Probes, Inc.

As stated herein, the agent may be labeled. As an example, if the agent is a nucleic acid, it may be labeled through the use of sequence-specific probes that bind to the polymer in a sequence-specific manner. The sequence-specific probes are labeled with a detectable label (e.g., a fluorophore or a radioisotope). The nucleic acid however can also be synthesized in a manner that incorporates fluorophores directly into the growing nucleic acid. For example, this latter labeling can be accomplished by chemical means or by the introduction of active amino or thiol groups into nucleic acids. (Proudnikov and Mirabekov, Nucleic Acid Research, 24:4535-4532, 1996.) An extensive description of modification procedures that can be performed on a nucleic acid polymer can be found in Hermanson, G. T., Bioconjugate Techniques, Academic Press, Inc., San Diego, 1996, which is incorporated by reference herein.

There are several known methods of direct chemical labeling of DNA (Hermanson, 1996; Roget et al., 1989; Proudnikov and Mirabekov, 1996). One of the methods is based on the introduction of aldehyde groups by partial depurination of DNA. Fluorescent labels with an attached hydrazine group are efficiently coupled with the aldehyde groups and the hydrazine bonds are stabilized by reduction with sodium labeling efficiencies around 60%. The reaction of cytosine with bisulfite in the presence of an excess of an amine fluorophore leads to transamination at the N4 position (Hermanson, 1996). Reaction conditions such as pH, amine fluorophore concentration, and incubation time and temperature affect the yield of products formed. At high concentrations of the amine fluorophore (3M), transamination can approach 100% (Draper and Gold, 1980).

In addition to the above method, it is also possible to synthesize nucleic acids de novo (e.g., using automated nucleic acid synthesizers) using fluorescently labeled nucleotides. Such nucleotides are commercially available from suppliers such as Amersham Pharmacia Biotech, Molecular Probes, and New England Nuclear/Perkin Elmer.

Probes are generally labeled with a detectable label. A detectable label is a moiety, the presence of which can be ascertained directly or indirectly. Generally, detection of the label involves the creation of a detectable signal such as for example an emission of energy. The label may be of a chemical, peptide or nucleic acid nature although it is not so limited. The nature of label used will depend on a variety of factors, including the nature of the analysis being conducted, the type of the energy source and detector used and the type of polymer and probe. The label should be sterically and chemically compatible with the constituents to which it is bound.

The label can be detected directly for example by its ability to emit and/or absorb electromagnetic radiation of a particular wavelength. A label can be detected indirectly for example by its ability to bind, recruit and, in some cases, cleave another moiety which itself may emit or absorb light of a particular wavelength (e.g., an epitope tag such as the FLAG epitope, an enzyme tag such as horseradish peroxidase, etc.). Generally the detectable label can be selected from the group consisting of directly detectable labels such as a fluorescent molecule (e.g., fluorescein, rhodamine, tetramethylrhodamine, R-phycoerythrin, Cy-3, Cy-5, Cy-7, Texas Red, Phar-Red, allophycocyanin (APC), fluorescein amine, eosin, dansyl, umbelliferone, 5-carboxyfluorescein (FAM), 2′7′-dimethoxy-4′5′-dichloro-6-carboxyfluorescein (JOE), 6 carboxyrhodamine (R6G), N,N,N′,N′-tetramethyl-6-carboxyrhodamine (TAMRA), 6-carboxy-X-rhodamine (ROX), 4-(4′-dimethylaminophenylazo)benzoic acid (DABCYL), 5-(2′-aminoethyl)aminonaphthalene-1-sulfonic acid (EDANS), 4-acetamido-4′-isothiocyanatostilbene-2,2′disulfonic acid, acridine, acridine isothiocyanate, r-amino-N-(3-vinylsulfonyl)phenylnaphthalimide-3,5, disulfonate (Lucifer Yellow VS), N-(4-anilino-1-naphthyl)maleimide, anthranilamide, Brilliant Yellow, coumarin, 7-amino-4-methylcoumarin, 7-amino-4-trifluoromethylcouluarin (Coumarin 151), cyanosine, 4′,6-diaminidino-2-phenylindole (DAPI), 5′,5″-diaminidino-2-phenylindole (DAPI), 5′,5″-dibromopyrogallol-sulfonephthalein (Bromopyrogallol Red), 7-diethylamino-3-(4′-isothiocyanatophenyl)-4-methylcoumarin diethylenetriamine pentaacetate, 4,4′-diisothiocyanatodihydro-stilbene-2,2′-disulfonic acid, 4,4′-diisothiocyanatostilbene-2,2′-disulfonic acid, 4-dimethylaminophenylazophenyl-4′-isothiocyanate (DABITC), eosin isothiocyanate, erythrosin B, erythrosin isothiocyanate, ethidium, 5-(4,6-dichlorotriazin-2-yl)aminofluorescein (DTAF), QFITC (XRITC), fluorescamine, IR144, IR1446, Malachite Green isothiocyanate, 4-methylumbelliferone, ortho cresolphthalein, nitrotyrosine, pararosaniline, Phenol Red, B-phycoerythrin, o-phthaldialdehyde, pyrene, pyrene butyrate, succinimidyl 1-pyrene butyrate, Reactive Red 4 (Cibacron® Brilliant Red 3B-A), lissamine rhodamine B sulfonyl chloride, rhodamine B, rhodamine 123, rhodamine X, sulforhodamine B, sulforhodamine 101, sulfonyl chloride derivative of sulforhodamine 101, tetramethyl rhodamine, riboflavin, rosolic acid, and terbium chelate derivatives), a chemiluminescent molecule, a bioluminescent molecule, a chromogenic molecule, a radioisotope (e.g., P³² or H³, ¹⁴C, ¹²⁵I and ¹³¹I), an electron spin resonance molecule (such as for example nitroxyl radicals), an optical or electron density molecule, an electrical charge transducing or transferring molecule, an electromagnetic molecule such as a magnetic or paramagnetic bead or particle, a semiconductor nanocrystal or nanoparticle (such as quantum dots described for example in U.S. Pat. No. 6,207,392 and commercially available from Quantum Dot Corporation and Evident Technologies), a colloidal metal, a colloid gold nanocrystal, a nuclear magnetic resonance molecule, and the like.

The detectable label can also be selected from the group consisting of indirectly detectable labels such as an enzyme (e.g., alkaline phosphatase, horseradish peroxidase, β-galactosidase, glucoamylase, lysozyme, luciferases such as firefly luciferase and bacterial luciferase (U.S. Pat. No. 4,737,456); saccharide oxidases such as glucose oxidase, galactose oxidase, and glucose-6-phosphate dehydrogenase; heterocyclic oxidases such as uricase and xanthine oxidase coupled to an enzyme that uses hydrogen peroxide to oxidize a dye precursor such as HRP, lactoperoxidase, or microperoxidase), an enzyme substrate, an affinity molecule, a ligand, a receptor, a biotin molecule, an avidin molecule, a streptavidin molecule, an antigen (e.g., epitope tags such as the FLAG or HA epitope), a hapten (e.g., biotin, pyridoxal, digoxigenin fluorescein and dinitrophenol), an antibody, an antibody fragment, a microbead, and the like. Antibody fragments include Fab, F(ab)₂, Fd and antibody fragments which include a CDR3 region.

In some embodiments, the detectable label is a member of a FRET fluorophore pair. FRET fluorophore pairs are two fluorophores that are capable of undergoing FRET to produce or eliminate a detectable signal when positioned in proximity to one another. Examples of donors include Alexa 488, Alexa 546, BODIPY 493, Oyster 556, Fluor (FAM), Cy3 and TMR (Tamra). Examples of acceptors include Cy5, Alexa 594, Alexa 647 and Oyster 656. Cy5 can work as a donor with Cy3, TMR or Alexa 546, as an example. FRET should be possible with any fluorophore pair having fluorescence maxima spaced at 50-100 nm from each other.

The polymer may be labeled in a sequence non-specific manner. For example, if the polymer is a nucleic acid such as DNA, then its backbone may be stained with a backbone label. Examples of backbone stains that label nucleic acids in a sequence non-specific manner include intercalating dyes such as phenanthridines and acridines (e.g., ethidium bromide, propidium iodide, hexidium iodide, dihydroethidium, ethidium homodimer-1 and -2, ethidium monoazide, and ACMA); minor grove binders such as indoles and imidazoles (e.g., Hoechst 33258, Hoechst 33342, Hoechst 34580 and DAPI); and miscellaneous nucleic acid stains such as acridine orange (also capable of intercalating), 7-AAD, actinomycin D, LDS751, and hydroxystilbamidine. All of the aforementioned nucleic acid stains are commercially available from suppliers such as Molecular Probes, Inc.

Still other examples of nucleic acid stains include the following dyes from Molecular Probes: cyanine dyes such as SYTOX Blue, SYTOX Green, SYTOX Orange, POPO-1, POPO-3, YOYO-1, YOYO-3, TOTO-1, TOTO-3, JOJO-1, LOLO-1, BOBO-1, BOBO-3, PO-PRO-1, PO-PRO-3, BO-PRO-1, BO-PRO-3, TO-PRO-1, TO-PRO-3, TO-PRO-5, JO-PRO-1, LO-PRO-1, YO-PRO-1, YO-PRO-3, PicoGreen, OliGreen, RiboGreen, SYBR Gold, SYBR Green I, SYBR Green II, SYBR DX, SYTO-40, -41, -42, -43, -44, -45 (blue), SYTO-13, -16, -24, -21, -23, -12, -11, -20, -22, -15, -14, -25 (green), SYTO-81, -80, -82, -83, -84, -85 (orange), SYTO-64, -17, -59, -61, -62, -60, -63 (red).

As used herein, “conjugated” means two entities stably bound to one another by any physiochemical means. It is important that the nature of the attachment is such that it does not substantially impair the effectiveness of either entity. Keeping these parameters in mind, any covalent or non-covalent linkage known to those of ordinary skill in the art may be employed. In some embodiments, covalent linkage is preferred. Noncovalent conjugation includes hydrophobic interactions, ionic interactions, high affinity interactions such as biotin-avidin and biotin-streptavidin complexation and other affinity interactions. Such means and methods of attachment are known to those of ordinary skill in the art.

The various components described herein can be conjugated to each other by any mechanism known in the art. For instance, functional groups which are reactive with various labels include, but are not limited to (functional group: reactive group of light emissive compound), activated ester:amines or anilines; acyl azide:amines or anilines; acyl halide:amines, anilines, alcohols or phenols; acyl nitrile:alcohols or phenols; aldehyde:amines or anilines; alkyl halide:amines, anilines, alcohols, phenols or thiols; alkyl sulfonate:thiols, alcohols or phenols; anhydride:alcohols, phenols, amines or anilines; aryl halide:thiols; aziridine:thiols or thioethers; carboxylic acid:amines, anilines, alcohols or alkyl halides; diazoalkane:carboxylic acids; epoxide:thiols; haloacetamide:thiols; halotriazine:amines, anilines or phenols; hydrazine:aldehydes or ketones; hydroxyamine:aldehydes or ketones; imido ester:amines or anilines; isocyanate:amines or anilines; and isothiocyanate:amines or anilines.

Linkers can be any of a variety of molecules, preferably nonactive, such as nucleotides or multiple nucleotides, straight or even branched saturated or unsaturated carbon chains of C₁-C₃₀, phospholipids, amino acids, and in particular glycine, and the like, whether naturally occurring or synthetic. Additional linkers include alkyl and alkenyl carbonates, carbamates, and carbamides. These are all related and may add polar functionality to the linkers such as the C₁-C₃₀ previously mentioned. As used herein, the terms linker and spacer are used interchangeably.

A wide variety of spacers can be used, many of which are commercially available, for example, from sources such as Boston Probes, Inc. (now Applied Biosystems). Spacers are not limited to organic spacers, and rather can be inorganic also (e.g., —O—Si—O—, or O—P—O—). Additionally, they can be heterogeneous in nature (e.g., composed of organic and inorganic elements). Essentially, any molecule having the appropriate size restrictions and capable of being linked to the various components such as fluorophore and probe can be used as a linker. Examples include the E linker (which also functions as a solubility enhancer), the X linker which is similar to the E linker, the 0 linker which is a glycol linker, and the P linker which includes a primary aromatic amino group (all supplied by Boston Probes, Inc., now Applied Biosystems). Other suitable linkers are acetyl linkers, 4-aminobenzoic acid containing linkers, Fmoc linkers, 4-aminobenzoic acid linkers, 8-amino-3,6-dioxactanoic acid linkers, succinimidyl maleimidyl methyl cyclohexane carboxylate linkers, succinyl linkers, and the like. Another example of a suitable linker is that described by Haralambidis et al. in U.S. Pat. No. 5,525,465, issued on Jun. 11, 1996.

The conjugations or modifications described herein employ routine chemistry, which is known to those skilled in the art of chemistry. The use of linkers such as mono- and hetero-bifunctional linkers is documented in the literature (e.g., Herman-Son, 1996) and will not be repeated here.

The linker molecules may be homo-bifunctional or hetero-bifunctional cross-linkers, depending upon the nature of the molecules to be conjugated. Homo-bifunctional cross-linkers have two identical reactive groups. Hetero-bifunctional cross-linkers are defined as having two different reactive groups that allow for sequential conjugation reaction. Various types of commercially available cross-linkers are reactive with one or more of the following groups: primary amines, secondary amines, sulphydryls, carboxyls, carbonyls and carbohydrates. Examples of amine-specific cross-linkers are bis(sulfosuccinimidyl)suberate, bis[2-(succinimidooxycarbonyloxy)ethyl]sulfone, disuccinimidyl suberate, disuccinimidyl tartarate, dimethyl adipimate.2HCl, dimethyl pimelimidate.2HCl, dimethyl suberimidate.2 HCl, and ethylene glycolbis-[succinimidyl-[succinate]]. Cross-linkers reactive with sulfhydryl groups include bismaleimidohexane, 1,4-di-[3′-(2′-pyridyldithio)-propionamido)]butane, 1-[p-azidosalicylamido]-4-[iodoacetamido]butane, and N-[4-(p-azidosalicylamido) butyl]-3′-[2′-pyridyldithio]propionamide. Cross-linkers preferentially reactive with carbohydrates include azidobenzoyl hydrazine. Cross-linkers preferentially reactive with carboxyl groups include 4-[p-azidosalicylamido]butylamine. Heterobifunctional cross-linkers that react with amines and sulfhydryls include N-succinimidyl-3-[2-pyridyldithio]propionate, succinimidyl [4-iodoacetyl]aminobenzoate, succinimidyl 4-[N-maleimidomethyl]cyclohexane-1-carboxylate, m-maleimidobenzoyl-N-hydroxysuccinimide ester, sulfosuccinimidyl 6-[3-[2-pyridyldithio]propionamido]hexanoate, and sulfosuccinimidyl 4-[N-maleimidomethyl]cyclohexane-1-carboxylate. Heterobifunctional cross-linkers that react with carboxyl and amine groups include 1-ethyl-3-[3-dimethylaminopropyl]-carbodiimide hydrochloride. Heterobifunctional cross-linkers that react with carbohydrates and sulfhydryls include 4-[N-maleimidomethyl]-cyclohexane-1-carboxylhydrazide.2 HCl, 4-(4-N-maleimidophenyl)-butyric acid hydrazide.2HCl, and 3-[2-pyridyldithio]propionyl hydrazide. The cross-linkers are bis-[β-4-azidosalicylamido)ethyl]disulfide and glutaraldehyde.

Amine or thiol groups may be added at any nucleotide of a synthetic nucleic acid so as to provide a point of attachment for a bifunctional cross-linker molecule. The nucleic acid may be synthesized incorporating conjugation-competent reagents such as Uni-Link AminoModifier, 3′-DMT-C6-Amine-ON CPG, AminoModifier II, N-TFA-C6-AminoModifier, C6-ThiolModifier, C6-Disulfide Phosphoramidite and C6-Disulfide CPG (Clontech, Palo Alto, Calif.).

Non-covalent methods of conjugation may also be used to bind a detectable label to a probe, for example. Non-covalent conjugation includes hydrophobic interactions, ionic interactions, high affinity interactions such as biotin-avidin and biotin-streptavidin complexation and other affinity interactions. As an example, a molecule such as avidin may be attached the nucleic acid, and its binding partner biotin may be attached to the probe.

In some instances, it may be desirable to use a linker or spacer comprising a bond that is cleavable under certain conditions. For example, the bond can be one that cleaves under normal physiological conditions or that can be caused to cleave specifically upon application of a stimulus such as light. Readily cleavable bonds include readily hydrolyzable bonds, for example, ester bonds, amide bonds and Schiff's base-type bonds. Bonds which are cleavable by light are known in the art.

After processing in the FFF chambers of the invention, the agent may be analyzed using a single molecule analysis system (e.g., a single polymer analysis system). A single molecule detection system is capable of analyzing single molecules separately from other molecules. Such a system may be capable of analyzing single molecules in a linear manner and/or in their totality. In certain embodiments in which detection is based predominately on the presence or absence of a signal, linear analysis may not be required. However, there are other embodiments embraced by the invention which would benefit from the ability to analyze linearly molecules (preferably nucleic acids) in a sample. These include applications in which the sequence of the nucleic acid is desired, or in which the polymers are distinguished based on spatial labeling pattern rather than a unique detectable label.

Thus, the polymers can be analyzed using linear polymer analysis systems. A linear polymer analysis system is a system that analyzes polymers such as nucleic acids, in a linear manner (i.e., starting at one location on the polymer and then proceeding linearly in either direction therefrom). As a polymer is analyzed, the detectable labels attached to it are detected in either a sequential or simultaneous manner. When detected simultaneously, the signals usually form an image of the polymer, from which distances between labels can be determined. When detected sequentially, the signals are viewed in histogram (signal intensity vs. time) that can then be translated into a map, with knowledge of the velocity of the polymer. It is to be understood that in some embodiments, the polymer is attached to a solid support, while in others it is free flowing. In either case, the velocity of the polymer as it moves past, for example, an interaction station or a detector, will aid in determining the position of the labels relative to each other and relative to other detectable markers that may be present on the polymer.

An example of a suitable system is the GeneEngine™ (U.S. Genomics, Inc., Woburn, Mass.). The Gene Engine™ system is described in PCT patent applications WO98/35012 and WO00/09757, published on Aug. 13, 1998, and Feb. 24, 2000, respectively, and in issued U.S. Pat. No. 6,355,420 B1, issued Mar. 12, 2002. The contents of these applications and patent, as well as those of other applications and patents, and references cited herein are incorporated by reference herein in their entirety. This system is both a single molecule analysis system and a linear polymer analysis system. It allows, for example, single nucleic acids to be passed through an interaction station in a linear manner, whereby the nucleotides in the nucleic acid are interrogated individually in order to determine whether there is a detectable label conjugated to the nucleic acid. Interrogation involves exposing the nucleic acid to an energy source such as optical radiation of a set wavelength. The mechanism for signal emission and detection will depend on the type of label sought to be detected, as described herein.

The systems described herein will encompass at least one detection system. The nature of such detection systems will depend upon the nature of the detectable label. The detection system can be selected from any number of detection systems known in the art. These include an electron spin resonance (ESR) detection system, a charge coupled device (CCD) detection system, a fluorescent detection system, an electrical detection system, a photographic film detection system, a chemiluminescent detection system, an enzyme detection system, an atomic force microscopy (AFM) detection system, a scanning tunneling microscopy (STM) detection system, an optical detection system, a nuclear magnetic resonance (NMR) detection system, a near field detection system, and a total internal reflection (TIR) detection system, many of which are electromagnetic detection systems.

Other single molecule nucleic acid analytical methods can also be used to analyze nucleic acid targets following the chamber based processing of the invention. These include fiber-fluorescence in situ hybridization (fiber-FISH) (Bensimon, A. et al., Science 265(5181):2096-2098 (1997)). In fiber-FISH, nucleic acid molecules are elongated and fixed on a surface by molecular combing. Hybridization with fluorescently labeled probe sequences allows determination of sequence landmarks on the nucleic acid molecules. The method requires fixation of elongated molecules so that molecular lengths and/or distances between markers can be measured. Pulse field gel electrophoresis can also be used to analyze the labeled nucleic acid molecules. Pulse field gel electrophoresis is described by Schwartz, D. C. et al., Cell 37(1):67-75 (1984). Other nucleic acid analysis systems are described by Otobe, K. et al., Nucleic Acids Res. 29(22):E109 (2001), Bensimon, A. et al. in U.S. Pat. No. 6,248,537, issued Jun. 19, 2001, Herrick, J. et al., Chromosome Res. 7(6):409:423 (1999), Schwartz in U.S. Pat. No. 6,150,089 issued Nov. 21, 2000 and U.S. Pat. No. 6,294,136, issued Sep. 25, 2001. Other linear polymer analysis systems can also be used, and the invention is not intended to be limited to solely those listed herein.

The present invention is further illustrated by the following Examples, which in no way should be construed as further limiting.

### EXAMPLES

### Example 1

### Comparison of a Single Chamber for DNA Isolation with a Typical Laboratory Protocol

The following are steps from a laboratory protocol developed to isolate high molecular weight genomic DNA from E. coli in solution. The method is designed to gently break open E. coli cells and to digest proteins with enzymes, while lipids are removed with mild/enzymes and detergents followed by dialysis.

Protocol:
1. Measure transmittance of overnight E. coli culture at 600 nm, dilute to between 70% and 15% transmittance.
2. Spin down the cells, decant media, and resuspend pellet in TE buffer and spin cells down again.
3. Decant buffer, resuspend cell pellet in the residual TE, and then add 4 mL of “bacterial lysis solution” with lysozyme to bacterial slurry.
4. Immediately mix gently, by swirling mixture and place at 37° C. for 2 hours, gently swirling the lysis periodically.
5. Add 20 μL of a 20 mg/mL solution of Proteinase K to cell lysis, mix gently, incubate at 37° C. for 2-4 hours.
6. Periodically, swirling gently until the lysis appears clear.
7. Add 780 μL of 5 M NaCl to achieve the final concentration of ˜800 mM NaCl and mix gently.
8. Use a P1000 pipette (with tip cut off) to add the appropriate volume of lysis to either a 3 mL or 5 mL 300 kD MWCO Spectra/POR Float-a-Lyzer.
9. The lysis is dialyzed overnight in 2 liters of TE buffer with a single change after 3 hours.
10. The sample is quantified and ready to be restriction enzyme digested.

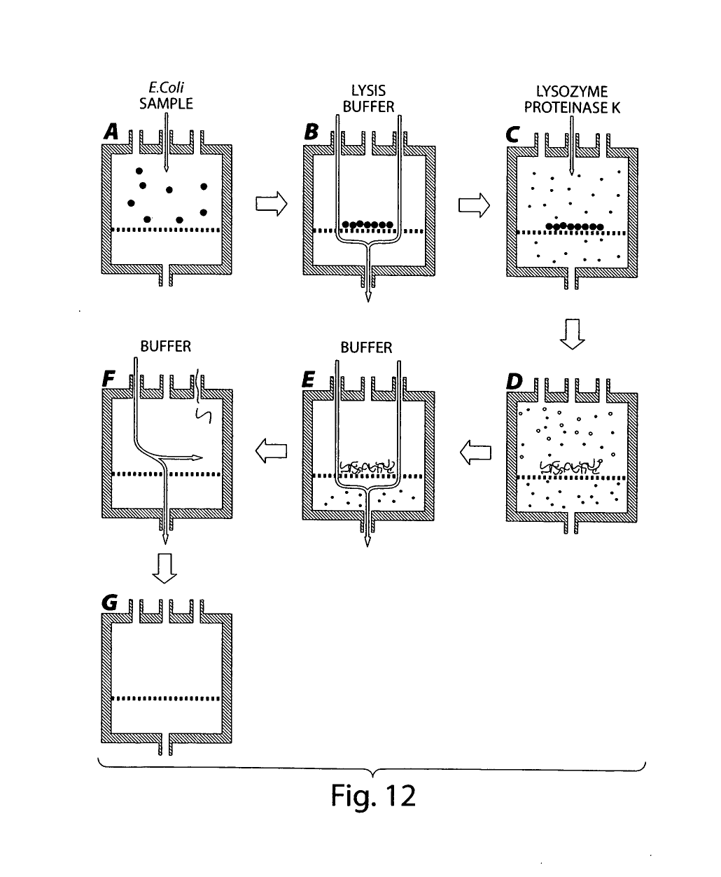

In comparison is the following isolation protocol envisioned with a single modular chamber as illustrated in FIG. 12.
A. A sample of E. coli (indicated by dots) is injected directly into the large compartment of the chamber. The sample and waste ports are open, while the other ports are closed (indicated by lines). While the sample solution can pass through the 300 kD ultrafiltration membrane, E. coli is too large and is retained in the large compartment. The chamber is maintained at an appropriate temperature for lysis. In another embodiment, the temperature of the chamber is raised and cooled at specific times during the isolation step.
B. Lysis buffer containing detergents such as deoxycholate and laurylsarcosine, is added to the chamber through the inlet and outlet ports. The original E. coli solution as well as excess lysis buffer is removed through the waste port. The addition of lysis buffer through both ports drives and focuses the E. coli towards and onto the membrane (relaxation procedure), immobilizing the bacteria on the surface as a uniform monolayer.
C. Lysozyme (indicated by diamonds) and proteinase K (also indicated by diamonds) are injected into the chamber. The enzymes fill the entire chamber, as they are small enough to diffuse through the ultrafiltration membrane.
D. The lysis is allowed to proceed in an enclosed system. In other embodiments, other mechanical systems such as gentle agitation could be included to accelerate the biochemical reaction. The result is the release of genomic DNA (indicated by dark lines) and waste materials (indicated by circles).
E. Buffer is added to the system, again through the inlet and outlet ports to remove all unwanted materials. The megabase DNA is too large to dialyze through the membrane and is hence retained in the large compartment.
F. Buffer is added through inlet port only and the genomic DNA is transferred through the outlet port to the next chamber for further processing. The waste port remains open, to allow for the continuous removal of unwanted material by dialysis. In another embodiment, buffer can flow in from the waste port to dislodge genomic DNA that is immobilized on the membrane and as before, transfers the DNA to the next chamber for further processing.
G. The isolation chamber is now ready to isolate DNA from another E. coli sample.

Performance time. The chamber for DNA isolation and the entire sample preparation system can be used to detect biowarfare or other biohazardous agents. Given the time constraints required by such applications, the isolation step can be performed for example in thirty minutes using the methods and systems of the invention compared to the many hours or even days using current isolation protocols. A considerable time saving can be had by substituting passive removal of waste material (via diffusion) with a flow system to actively remove unwanted material as provided by the invention. Automating the system will also lead to time savings. The chamber itself is simple and robust. Mechanical systems such as pumps and valves to drive and direct fluid flow through the system are based on known and tested liquid chromatography equipment. Hence, the system can be run autonomously for long periods of time before servicing is required.

Performance costs. The chamber can be reused, resulting in cost savings. It may also be possible to recycle reagents, particularly costly reagents, thereby leading to cost savings. Savings are also incurred by the reduced labor with operating the device.

Sample degradation. One major concern when working with high molecular weight DNA is degradation by shearing. The use of chambers as provided by the invention reduces or eliminates this concern. For example, use of a chamber for a preparative step such as DNA isolation reduces the amount of sample handling. Current protocols, on the other hand, involve frequent transfers of buffers and samples from one container to another. Human error, a potential source for DNA degradation, is also reduced or eliminated. It will be recognized by those of ordinary skill in the art that the reduction in handling and the errors associated therewith will maximize yield and lead to more accurate analysis and results.

It is further to be understood that the methods and systems of the invention provide a modular chamber-based approach to mini- or maxi-preparation of nucleic acids from a variety of sources as well as subsequent modification of such nucleic acids. Microgram amounts of nucleic acids typically can be prepared according to the invention. Importantly, the nucleic acids thus prepared would be substantially undegraded, for example by shearing, and sizes of at least 50 kb will typically be possible. The methods and systems of the invention may or may not embrace growth of cells, viruses, etc. within the chamber as one of the processing steps. In some embodiments, they do not particularly since such agent amplification may introduce artifacts into the sample.

### Example 2

### DNA Digestion, DNA Tagging and DNA Fractionation

As noted previously, while the DNA isolation step is the only one shown in detail for brevity, the same performance advantages provided by a modular chamber are expected for DNA digestion and DNA labeling. By altering the operating parameters for a chamber, such as buffer type, operating temperature and time, and membrane type, one can use the modular chamber for digestion, labeling or other biochemical protocols. The modular chamber and its basic design principal, a temperature-controlled compartment divided by a semi-permeable membrane, remain the same. The addition and removal of fluid, sample and waste also remain as illustrated in FIG. 12.

For example, DNA digestion would require a unique buffer system for the reaction to occur. The restriction enzyme required for the digestion is injected into the large compartment containing the DNA and the entire system is incubated at ˜40° C. The actual incubation time can be less than 10 minutes, depending on the enzyme used, its concentration, the operating temperature and buffer composition. For DNA labeling, sequence-specific probes are introduced into the chamber and are incubated with the fragmented DNA contained therein. Excess probes are removed by fast dialysis.

By performing multiple processing steps in one chamber, total processing time can be reduced by several hours instead of the days required using current techniques. If the device or method comprises chambers in parallel, the number of samples which can be processed at a given time is increased. It is also contemplated that introduction of a new sample into a multi-chamber (in series) system can occur at regularly spaced intervals, thereby approximating an “assembly line” approach as various samples move through the different processing stages.

### Example 3

### Comparison of the Proposed System to a Reported Field Investigation of Bacillus anthracis Via Air Sampling

A field investigation of Bacillus anthracis was performed on a variety of samples, including surface swabs and air samples (Higgins, J. A., et al., Applied and Environmental Microbiology, 2003. 69(1): p. 593-599). To prepare the air sample for real time polymerase chain reaction (PCR) analysis, the air sample was centrifuged and the resulting pellet was resuspended and subjected to a unique rapid DNA extraction kit. Since the sample was centrifuged to form a pellet, any contaminants that were also collected would be present during DNA extraction. This can reduce DNA extraction efficiency. As well, contamination could adversely affect the final detection method.

In comparison, the system and method of the invention would allow one to extract high molecular weight DNA from the pathogen, and thus detection is not restricted to PCR methods. Performance time would be equivalent using the chamber system. If necessary, the rapid DNA extraction kit could be adapted to extract DNA of necessary length for analysis using GeneEngine™ technology. One clear benefit is the ability to sort the bioaerosol prior to sample preparation using the proposed system. In doing so, various biological samples can be analyzed in parallel and sample loss is reduced.

### REFERENCES

Basel, R. M., E. R. Richter, and G. J. Banwart, Monitoring microbial numbers in food by density centrifugation. Applied and Environmental Microbiology, 1983. 45(3): p. 1156-1159.
Bender, J. B., et al., Surveillance for Escherichia coli O157:H7 Infections in Minnesota by Molecular Subtyping. New England Journal of Medicine, 1997. 337(6): p. 388-394.
Cox, C. S, and C. M. Wathes, eds. Bioaerosols Handbook. 1995, Lewis Publishers: Boca Raton.
Giddings, J. C., The Field-Flow Fractionation Family: Underlying Principles, in Field-Flow Fractionation Handbook, M. Schimpf, K. Caldwell, and J. C. Giddings, Editors. 2000, Wiley-Interscience: New York. p. 3-30.
Higgins, J. A., et al., A field investigation of Bacillus anthracis contamination of U.S. department of agriculture and other Washington D.C. buildings during the anthrax attack of October 2001. Applied and Environmental Microbiology, 2003. 69(1): p. 593-599.
Ito, Y. and K. Shinomiya, A new continuous-flow cell separation method based on cell density: Principle, apparatus, and preliminary application to separation of human buffy coat. Journal of Clinical Apheresis, 2001. 16: p. 186-191.
Kucerova, Z., et al., Purification of Enterocytozoon bieneusi spores from stool specimens by gradient and cell sorting techniques. Journal of Clinical Microbiology, 2004. 42(7): p. 3256-3261.
Lee, B. U. and S. S. Kim, Sampling of E. coli and B. Subtilis bacteria bioaerosols by a new type of impactor with a cooled impaction plate. Journal of Aerosol Science, 2003. 34: p. 1097-1100.
Lee, H., et al., Analysis of Self-Assembled Cationic Lipid-DNA Gene Carrier Complexes using Flow Field-Flow Fractionation and Light Scattering. Analytical Chemistry, 2001. 73(4): p. 837-843.
Li, P. and M. Hansen, Protein Complexes and Lipoproteins, in Field-Flow Fractionation Handbook, J. C. Giddings, Editor. 2000, Wiley-Interscience: New York. p. 433-470.
Lindqvist, R., B. Norling, and S. T. Lambertz, A rapid sample preparation method for PCR detection of food pathogens based on buoyant density centrifugation. Letters in Applied Microbiology, 1997. 24: p. 306-310.
Liu, M.-K. and J. C. Giddings, Separation and Measurement of Diffusion Coefficients of Linear and Circular DNAs by Flow Field-Flow Fractionation. Macromolecules, 1993. 26(14): p. 3576-3588.
Matsumoto, M., et al., Screening of buoyant marine cyanobacteria using sucrose gradient centrifugation. Journal of Applied Psychology, 2002. 14: p. 91-95.
Noller, A. C., et al., Multilocus Sequence Typing reveals a Lack of Diversity among Escherichia coli O157:H7 Isolates that are Distinct by Pulsed-Field Gel Electrophoresis. Journal of Clinical Microbiology, 2003. 41(2): p. 675-679.
Schels, H., H. Menzler, and U. Fischer, Bioreaction Module for Biochemical Reactions, U.S. Pat. No. 6,670,173. 2003, Roche Diagnostics GmbH (DE): USA.
Stetzenbach, L. D., M. P. Buttner, and P. Cruz, Detection and enumeration of airborne contaminants. Current Opinion in Biotechnology, 2004. 15: p. 170-174.
Wahlund, K.-G. and A. Litzén, Application of an Asymmetrical Flow Field-Flow Fractionation Channel to the Separation and Characterization of Proteins, Plasmid Fragments, Polysaccharides and Unicellular Algae. Journal of Chromatography, 1989. 461: p. 73-87.

### EQUIVALENTS

The foregoing written specification is considered to be sufficient to enable one skilled in the art to practice the invention. The present invention is not to be limited in scope by examples provided, since the examples are intended as a single illustration of one aspect of the invention and other functionally equivalent embodiments are within the scope of the invention. Various modifications of the invention in addition to those shown and described herein will become apparent to those skilled in the art from the foregoing description and fall within the scope of the invention. The advantages and objects of the invention are not necessarily encompassed by each embodiment of the invention.

All references, patents and patent applications that are recited in this application are incorporated by reference herein in their entirety.

What is claimed is:

1. A method for modifying an agent comprising
providing a field flow fractionation channel,
introducing an agent and at least one reagent capable of reacting with the agent into the field-flow fractionation channel, and
maintaining the agent and the at least one reagent in the channel for a time, and under conditions, suitable to allow the at least one reagent to react with and modify the agent.

2. A method for modifying an agent comprising
providing a channel having an upstream portion and a downstream portion, the channel defined at least by a first wall and a second wall closely spaced from the first wall, the channel constructed and arranged to transport carrier fluids containing the agent and at least one reagent capable of reacting with the agent from the upstream portion and toward the downstream portion between the first and second walls;
flowing the carrier fluids containing the agent and the at least one reagent toward the downstream portion in laminar flow;
allowing a transverse force to act on the carrier fluid and its contents, the transverse force adapted to move at least the agent toward the first wall;
holding the agent at the first wall; and
allowing the at least one reagent to react with and modify the agent in the channel.

3. The method of claim 2, wherein the carrier fluid containing the agent is introduced into the channel at a different time than the carrier fluid containing the at least one reagent.

4. The method of claim 2, wherein holding the agent at the first wall comprises increasing a magnitude of the transverse force.

5. The method of claim 4, further comprising:
releasing the agent from the first wall by decreasing the magnitude of the transverse force.

6. The method of claim 2, wherein holding the agent at the first wall comprises stopping carrier fluid from flowing through the channel.

7. The method of claim 2, further comprising positioning the agent between the upstream and downstream portion of the channel by flowing fluid into the channel from both the downstream and the upstream portions.

8. The method of claim 2, further comprising
removing the carrier fluid from the channel; and
flowing an additional fluid into the channel, the additional fluid having a composition different than the carrier fluid removed from the channel.

9. The method of claim 2, wherein the at least one reagent lyses the agent.

10. The method of claim 2, wherein the at least one reagent is a probe specific for the agent.

11. The method of claim 2, further comprising
flowing an additional carrier fluid in the channel toward the downstream portion; and
removing the agents from the channel with the additional carrier fluid.

12. The method of claim 2, further comprising removal of the at least one reagent prior to analysis of the agent.

13. The method of claim 11, further comprising
providing a second channel having an upstream portion, a downstream portion, the second channel defined at least by a first wall and a second wall closely spaced from the first wall of the second channel, the second channel constructed and arranged to transport the additional carrier fluid from the upstream portion of the second channel and toward the downstream portion of the second channel while between the first and second walls of the second channel;
flowing the additional carrier fluid toward the downstream portion of the second channel;
allowing an additional transverse force to act on the fluid and its contents within the second channel, the additional transverse force adapted to move the agent toward the first wall of the second channel;
holding the agent at the first wall of the second channel; and
modifying the agent in the second channel.

14.-47. (canceled)

48. A method for modifying an agent comprising
providing a carrier fluid containing agents and debris;
removing debris from the carrier fluid based on hydrodynamic size and buoyant density;
providing a channel having an upstream portion and a downstream portion, the channel defined at least by a first wall and a second wall closely spaced from the first wall, the channel constructed and arranged to transport the carrier fluid from the upstream portion and toward the downstream portion with the carrier fluid located between the first and second walls;
providing the carrier fluid containing the agents to the channel near the upstream portion;
flowing the carrier fluid toward the downstream portion in laminar flow;
allowing a transverse force to act on the agents in the carrier fluid, the transverse force adapted to move the agent toward the first wall; and
holding the agents on the first wall.

49. A method for modifying an agent comprising
providing a carrier fluid containing at least a first and a second agent;
separating the first agent from the second agent based on hydrodynamic size and buoyant density;
providing a channel having an upstream portion and a downstream portion, the channel defined at least by a first wall and a second wall closely spaced from the first wall, the channel constructed and arranged to transport the carrier fluid from the upstream portion and toward the downstream portion with the carrier fluid located between the first and second walls;
providing a carrier fluid containing the first agent to the channel near the upstream portion;
flowing the carrier fluid toward the downstream portion in laminar flow;
allowing a transverse force to act on the first agent in the carrier fluid, the transverse force adapted to move the first agent toward the first wall; and
holding the first agent on the first wall.

50. A system for modifying an agent comprising
a plurality of chambers, each of the chambers comprising:
a channel with an upstream portion and a downstream portion, the channel defined at least in part by a first wall and a second wall closely spaced from the first wall, the channel constructed and arranged to transport a carrier fluid containing a agent toward the downstream portion with the carrier fluid located between the first and second walls;
an apparatus adapted to allow a transverse force to act on the agent in the channel to move the agent toward the first wall; and
a controller adapted to adjust a flow rate of fluid in the channel and to adjust a magnitude of the transverse force to hold the agent on the first wall; and
a fluidic connection adapted to transport carrier fluid containing the agent from a first of the plurality of chambers to a second of the plurality of chambers.

51. A reconfigurable chamber for modifying an agent comprising
a channel with an upstream portion and a downstream portion, the channel defined at least in part by a first wall and a second wall closely spaced from the first wall, the channel constructed and arranged to transport a carrier fluid containing an agent toward the downstream portion with the carrier fluid located between the first and second walls, wherein the first and second walls are adapted to be separated from one another by a spacer that defines a channel height between the first and second walls;
a fluid inlet for introducing carrier fluid including the agent into the upstream portion of the channel;
an apparatus adapted to allow a transverse force to act on the agent in the channel to move the agent toward the first wall; and
a plurality of fluid outlets, each adapted to remove at least a portion of the carrier fluid from the channel and each spaced from the inlet to define a corresponding channel length;
a plurality of spacers each adapted to be placed between the first wall and the second wall to define the channel height and each having a differently sized aperture that extends between the inlet and at least one of the outlets to define the channel length.

52. A chamber for modifying an agent comprising
a housing;
a channel in the housing, the channel having an upstream portion and a downstream portion and the channel being defined at least in part by a first wall and a second wall closely spaced from the first wall, the channel constructed and arranged to transport a carrier fluid containing the agent from the upstream portion and toward the downstream portion between the first and second walls; and
a support adapted to provide support to the first wall;
a cassette that includes the first wall and the support, the cassette being removable from the housing as a unit to facilitate replacement of the first wall; and
an apparatus adapted to allow a transverse force to act on the agent in the channel to move the agent toward and hold the agent on the first wall.

53. A chamber for modifying an agent comprising
a housing;
a channel in the housing, the channel having an upstream portion and a downstream portion and the channel being defined at least by a first wall and a second wall closely spaced from the first wall, the channel constructed and arranged to transport a carrier fluid containing an agent from the upstream portion and toward the downstream portion between the first and second walls; and
an apparatus adapted to allow a transverse force to act on the agent in the channel to move the agent toward and hold the agent at the first wall; and
a temperature control adapted to maintain the carrier fluid at a desired temperature.

54. A chamber for modifying an agent comprising
a channel in the housing, the channel having an upstream portion and a downstream portion and the channel being defined at least in part by a first porous wall and a second wall closely spaced from the first porous wall, the channel constructed and arranged to transport a carrier fluid containing an agent from the upstream portion and toward the downstream portion between the first and second walls;
a carrier fluid inlet in the upstream portion of the channel;
a cross flow fluid inlet in the upstream portion of the channel, the cross flow fluid inlet providing fluid communication to the channel for cross flow fluid that, when drawn through the first porous wall, allows a transverse force that acts on the agent by moving the agent toward the first porous wall;
an introduction channel that provides fluid communication between the upstream portion of the channel and each of the carrier fluid inlet and the cross flow fluid inlet, the introduction channel adapted to introduce each of the carrier fluid and the cross flow fluid in the upstream portion of the channel such that the carrier fluid and the cross flow fluid are layered between the closely spaced walls when in the upstream portion of the channel.
